(19) United States
(12) Patent Application Publication
(10) Pub. No.: US 2010/0250271 A1
(43) Pub. Date: Sep. 30, 2010

(54) METHOD AND SYSTEM FOR DIGITAL HEALTHCARE PLATFORM

(75) Inventors: Jonathan Day Pearce, St. Paul, MN (US); Stephen Robert Claypool, Minneapolis, MN (US); Conrad Hancock Barski, Washington, DC (US); Fredrick Richard Krieger, Orono, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Zipnosis, Inc., Minneapolis, MN (US)

(21) Appl. No.: 12/632,458

(22) Filed: Dec. 7, 2009

Related U.S. Application Data
(60) Provisional application No. 61/164,723, filed on Mar. 30, 2009.

(51) Int. Cl. G06Q 50/00

(52) U.S. Cl. 705/2

(57) ABSTRACT

The presently disclosed digital healthcare platform provides patients and healthcare providers with a precise and focused treatment pathway to address healthcare issues. One embodiment enables a patient-initiated e-Visit to address a healthcare issue with an issue-focused adaptive interview. The results of this adaptive interview are forwarded to a skilled clinician for review, who then provides an assessment and a plan of action for the issue. The plan of action may include specific instructions, a prescription, or a referral to a third party medical provider for testing, consultation, or treatment. Another embodiment provides an identification “ticket” to the patient to coordinate care obtained at third parties. The ticket can be presented by the patient to a third party medical provider (such as with a barcode displayed on a mobile device) to identify the patient and enable the third party medical provider to access patient information from the digital healthcare platform.

### CROSS REFERENCE TO RELATED APPLICATIONS

This application claims priority to U.S. provisional application Ser. No. 61/164,723, filed Mar. 30, 2009, entitled “SYSTEMS AND METHODS FOR CAPTURE AND IMPORTATION OF MEDICAL AND VITAL DATA THROUGH HEADSET PLUG IN A COMPUTING DEVICE,” which is hereby incorporated by reference in its entirety.

### FIELD OF THE INVENTION

The present invention generally relates to information and data management techniques relevant to medical related data and health care visits. The present invention more specifically relates to a method and system used to collect, manage, coordinate, and transfer electronic medical data from a patient among multiple healthcare settings.

### BACKGROUND OF THE INVENTION

Patients currently have limited options when faced with non-life threatening symptoms of an ongoing medical issue. These options include: 1) Quick Service Clinic—A patient may seek care with a practitioner-staffed clinic, such as MINUTECLINIC™. Although these quick service clinics offer fast, walk-in care, there are few locations nationwide, and these clinics are limited to resolving only selected minor medical problems. 2) Phone Calls—A patient may call a doctor or a nurse line to obtain medical advice. However, doctors are hard to reach, patients often must call multiple times to reach a doctor during business hours, and generally doctors are not paid for phone calls. Nurses are more accessible, but cannot access patient history and have a limited ability to resolve problems via phone. The typical result of a phone call is to encourage the patient to visit the doctor in person. 3) Urgent Care Clinic/ER—This option offers walk-in care, but this is an expensive and time-consuming alternative to scheduling a visit. 4) Primary care clinic—This setting offers the right type of care for non-life threatening symptoms, but many primary care clinics are hard to get into, provide relatively expensive diagnosis, and are inconvenient.

Often, when faced with generally minor symptoms, the patient will do nothing, an expensive and dangerous alternative but the only option for millions of patients who lack healthcare insurance or do not have a primary care doctor relationship. Many health care issues cannot be addressed if the patient is unable to obtain primary care and treat the condition.

A limited solution to primary care health issues are electronic medical consultations. Electronic medical consultations (commonly referred to as “e-Visits”) have been around in various forms since the late 1990s, and have involved various uses of video, sound, and text for the doctor-patient communication. However, reimbursement, efficacy, and technology barriers have slowed adoption over the past decade. In 2004, the reimbursement issue was resolved when a standardized billing code was created for e-Visits. In 2007, the efficacy hurdle was addressed to a limited extent when the American Academy of Family Physicians formally endorsed e-Visits as a viable treatment method. However, there are still shortcomings with existing solutions because they are typically unable to offer complete testing and treatment of a medical issue, and encounter the same scheduling and accessibility constraints as phone calls or direct communications.

Other electronic platforms for doctor-patient communication have failed to fully address the needs of typical healthcare scenarios and streamline the care process for patients. Although different types of electronic healthcare interfaces exist, such as secure clinic websites, many of these interfaces are limited to “in-network” or hospital system contact with only selected healthcare providers. Additionally, many of these healthcare interfaces are limited to the exchange of typed messages between the patient and the doctor, ending in similar incomplete results as phone contact and e-Visits.

The various embodiments of the present invention directly address the key technological barriers to e-Visits and electronic patient care by offering a consumer-focused health care delivery model. Additionally, the various embodiments of the present invention address the shortcomings of existing electronic healthcare platforms by streamlining responses to typical medical issues and integrating services with multiple third party medical providers.

### BRIEF SUMMARY OF THE INVENTION

One aspect of the present invention includes the use of a digital healthcare platform to provide a set of dynamic patient care interfaces to address health care issues. The digital healthcare platform integrates the focused and direct communication features of an e-Visit with an adaptive interview and medical professional analysis to create a powerful triage tool accessible in numerous settings or locations. The presently disclosed digital healthcare platform is further configured to enable a clinician to readily diagnose the patient's health care issue online, provide instructions to the patient in a user-friendly format, and route the patient to a healthcare provider for further testing and treatment as necessary. Additionally, the digital healthcare platform enables use of a front end digital gateway portal to be integrated into web or portable devices to resolve or triage healthcare needs in a consumer-driven solution.

Another aspect of the present invention enables healthcare visits and documentation requirements to be portable and controlled by the patient. The presently disclosed platform can act to provide a powerful triage tool on mobile devices that closely matches a clinical assessment with patient needs, thereby enabling low-cost, efficient routing throughout the episode of care. Using a portable identifier as a routing tool, referred to herein as a “Ticket,” the presently disclosed digital healthcare platform can also direct the patients to the right place for the correct care.

Still another aspect of the present invention includes providing the ability to dramatically improve care throughput by frontloading the patient's diagnostic data prior to engaging a clinician. The platform operates to assist the clinician in generating a plan of action and making the diagnostic data and plan of action accessible to third party healthcare providers with the single Ticket identifier. This results in highly-efficient, low-cost clinical encounters.

With implementation of the various aspects of the present invention on a smartphone mobile device, a patient's mobile device can act similar to a healthcare “smart card” and offer portability to patient visits at one or more third party medical providers. For example, a basic medical history and physical (“H&P”) of the e-Visit can be accessed at a quick service clinic or a full-service clinic by reading a user-provided barcode identifier Ticket displayed on the patient's mobile device. Moreover, the presently disclosed system provides patients with an adaptable method to direct healthcare treatment and quickly resolve health problems, thereby lowering the overall cost of healthcare for both consumers and providers.

Other aspects of the digital healthcare platform include offering instructions, prescriptions, education, and other focused materials delivered to the patient. For example, the digital healthcare platform may provide relevant coupons and offers for over-the-counter medications when an online assessment is made but no prescription is offered. The health care platform may utilize keywords contained within a clinician's response to suggest over-the-counter solutions or patient education on the healthcare issue. These features enable the digital healthcare platform and its user interfaces to address patient satisfaction with low-cost solutions, particularly for minor health problems.

One aspect of the present invention includes techniques for facilitating a patient-driven healthcare interaction with the patient by providing an advanced information intake and clinician analysis facilitated through a digital healthcare platform. In this embodiment, an adaptive healthcare interview is first performed with the patient, and is then translated into clinical text by a computerized expert system for review by a skilled clinician. The adaptive healthcare interview is presented to a patient with a navigable interface on an electronic device. The expert system analyzes the adaptive healthcare interview to provide one or more suggested assessments and suggested actions to address the healthcare issue. In response to the adaptive interview and relevant patient medical history, the clinician reviews the suggestions, and completes an assessment of the healthcare issue and recommends a plan of action. The assessment and plan of action are translated into patient friendly instructions with use of the expert system, and are ultimately presented back to the patient within the interface. The instructions include an explanation of the assessed healthcare issue and action plan steps to take, and may be accompanied by specific advice, prescriptions, referrals to third party medical providers, educational materials, coupons, or other information related to the healthcare issue. One further embodiment enables access to the patient interfaces using smartphones and other mobile devices. Another further embodiment enables integration of data from medical monitoring devices into the data collected during the adaptive interview. Yet another further embodiment provides for creating a unique identifier for patient use at selected third parties in conjunction with the third party medical or service referrals.

Another aspect of the present invention includes techniques for facilitating a patient-driven healthcare interaction with the patient using a mobile device and a healthcare “Ticket” identifier. In this embodiment, a Ticket is generated in response to the patient interaction with the digital healthcare platform, which includes an adaptive interview and the clinician-edited assessment and plan of action. Patient instructions relevant to the healthcare issue are provided to the patient, including action to be taken at a third party medical provider. Relevant data associated with the plan of action and the clinician's assessment is stored in a database and associated with the Ticket. The Ticket is accessed via a patient's mobile device, and is displayed on the mobile device for direct presentation at the third party medical provider. The third party medical provider reads the identifier (such as a barcode) on the Ticket to identify the patient's health issue and ultimately retrieve patient care information from the digital healthcare platform. The third party medical provider connects and authenticates to the digital healthcare platform and transmits the identifier. Data relevant to the patient and the healthcare issue is then transmitted to the third party medical provider from the digital healthcare platform.

Yet another aspect of the present invention includes techniques for facilitating a patient-driven healthcare interaction with the patient using the digital healthcare platform, by providing enhanced information flow and healthcare services among multiple parties. The digital healthcare platform acts to coordinate required information among disparate parties: the patient, an initial clinician, and a plurality of third party medical providers. In one embodiment, information relevant to a healthcare issue is collected from the patient via an adaptive interview, and collected and analyzed at the digital healthcare platform. This information is translated and provided to an initial clinician for review. The clinician generates a medical assessment and a plan of action assisted by automated tools within the digital healthcare platform. The clinician also establishes action items which require resolution at a third party medical provider. The digital healthcare platform streamlines the referring process to third party medical providers for the patient, by enabling the patient to select appropriate third parties from a list of eligible medical providers. When the patient visits the third party medical provider, information relevant to the healthcare issue is transmitted to the third party medical provider from the digital healthcare platform. In further embodiments, the clinician or the third party medical provider may also retrieve and make use of electronic medical records from a medical record entity.

### BRIEF DESCRIPTION OF THE DRAWINGS

FIG. 1 illustrates a flowchart of a summarized process for a patient-driven electronic healthcare interaction according to one embodiment of the present invention;

FIG. 2 illustrates a diagram of the various communication and interaction components of the digital healthcare platform according to one embodiment of the present invention;

FIG. 3 illustrates a diagram of the various data components accessed in the digital healthcare platform according to one embodiment of the present invention;

FIG. 4A illustrates a screenshot of an adaptive interview interface provided according to one embodiment of the present invention;

FIG. 4B illustrates another screenshot of an adaptive interview interface provided according to one embodiment of the present invention;

FIG. 4C illustrates another screenshot of an adaptive interview interface provided according to one embodiment of the present invention;

FIG. 4D illustrates a screenshot of an adaptive interview interface with a patient data input provided according to one embodiment of the present invention;

FIG. 5 illustrates a screenshot of a clinical interface provided according to one embodiment of the present invention;

FIG. 6A illustrates interaction within a screenshot of the clinical note portion of the clinical interface screenshot in FIG. 5 provided according to one embodiment of the present invention;

FIG. 6B illustrates interaction within a screenshot of the assessment portion of the clinical interface screenshot in FIG. 5 provided according to one embodiment of the present invention;

FIG. 6C illustrates interaction within a screenshot of the plan of action portion of the clinical interface screenshot in FIG. 5 provided according to one embodiment of the present invention;

FIG. 6D illustrates interaction within a screenshot of the plan of action and patient recommendation text portions of the clinical interface screenshot in FIG. 5 provided according to one embodiment of the present invention;

FIG. 6E illustrates interaction within a screenshot of the plan of action and patient recommendation text portions of the clinical interface screenshot in FIG. 5 provided according to another embodiment of the present invention;

FIG. 7A illustrates a screenshot of a patient user interface displaying a plan of action and patient recommendation text according to one embodiment of the present invention;

FIG. 7B illustrates a screenshot of a patient user interface for selecting a healthcare service location displayed on a patient mobile device according to one embodiment of the present invention;

FIG. 8 illustrates a barcode identifier Ticket displayed on a patient mobile device interface according to one embodiment of the present invention;

FIG. 9 illustrates an example use of a barcode identifier Ticket by a patient at a third party healthcare provider according to one embodiment of the present invention;

FIG. 10 illustrates a screenshot of a clinical interface displaying a plan of action relevant to the third party healthcare provider according to one embodiment of the present invention;

FIG. 11 illustrates a standardized 2.5 mm TRS connector headset plug and 2.5 mm TRS connector headset jack on a mobile computing device used with one embodiment of the present invention;

FIG. 12 illustrates an example use of a portable medical monitoring device and a mobile computing device connected via a headset connector used with one embodiment of the present invention; and

FIG. 13 illustrates an operation of capturing and importing medical data through a headset connection used with one embodiment of the present invention.

### DETAILED DESCRIPTION OF THE INVENTION

The various embodiments of the presently disclosed digital healthcare platform invention enable advanced healthcare services to be initiated with a single e-Visit patient interaction. These embodiments are used to create a healthcare action plan for a patient health issue and provide a patient-friendly adaptive interview and a clinician assessment of the interview results. Through use of the adaptive interview, a clinician can be contacted with minimal or no typing, and as a result opportunities for patient error are diminished. Further, the clinician is able to review the results of the adaptive interview and provide a probable assessment and a plan of action to address the issue, including instructions, a referral to a third party for consultation or treatment, prescriptions, testing, education, and the like. In this way, the digital healthcare platform acts similar to an urgent care triage, enabling accurate and timely e-Visit interactions for a patient to resolve and triage their healthcare needs.

The various embodiments employ a digital healthcare platform that makes use of an expert system to increase clinician efficiency and triage accuracy. The expert system serves as a robust medicine decision tool to facilitate the creation of in-depth and focused patient interviews for a variety of medical conditions. The expert system also assists the clinician by translating the patient interviews into a natural language clinical note, presenting relevant options to the clinician based on the adaptive interview, and translating the clinician-selected action items into patient-friendly text.

Further, the presently described digital healthcare platform facilitates a comprehensive digital record of the e-Visit and patient/clinician interaction. The platform can generate a ready-to-review clinic note and care recommendations for use at a third party healthcare provider, such as primary care doctor or a testing center. Additionally, further embodiments of the present invention also integrate the adaptive interview and clinician review with the patient's existing health data or electronic medical records, thereby providing interested parties with a more comprehensive and accurate summary and status of the patient's condition and medical history.

Another advantage of the presently disclosed digital healthcare platform is flexible deployment and enabled mobility for the patient end-user. One embodiment includes a patient website interface that does not require extensive computing hardware, and therefore can be deployed on mobile communication devices such as smartphones. Specifically, the adaptive interview for the healthcare issue can be presented to the patient through any mobile device or web-supporting computing platform. Support for the mobile modules does not require re-writing the infrastructure for the digital healthcare platform, making it fast and cost-efficient to expand to other areas and with other techniques.

The following is a discussion of the overall processes and architectures deployable in the presently disclosed digital healthcare platform. This discussion is followed by specific implementation details for (a) the patient adaptive interview, (b) the clinician assessment and creation of a plan of action, (c) use of a unique identifier assigned to the patient, (d) use of the unique identifier at appropriate third party service or medical providers; and (e) integration of the digital healthcare platform with external monitoring devices.

Overall Process of Digital Healthcare Platform Interactions

As previously discussed, the presently disclosed digital healthcare platform initiates its interaction with the patient through an e-Visit. e-Visits are effective for addressing minor medical problems in otherwise generally healthy patients, such as sore throats, colds, and rashes, as well as regular touch points for chronic conditions like depression and diabetes. Although the following provides applicability and examples for such minor medical problems, those skilled in the art will recognize that adaptations of the present invention may also be applicable to a wide variety of health issues and scenarios, including moderate and complicated medical problems.

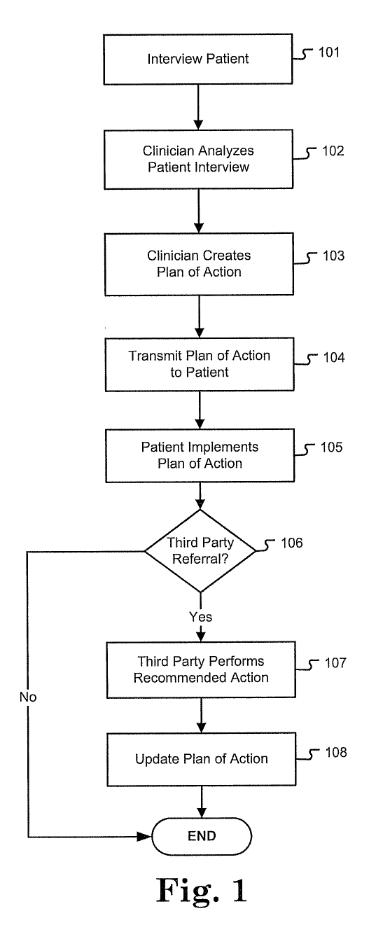

FIG. 1 displays a flowchart demonstrating the high-level steps of patient care that are facilitated through use of the presently disclosed digital healthcare platform. First, as in step 101, the patient is interviewed with an adaptive interview. The adaptive interview presents a series of questions to collect relevant data from the patient regarding his or her health issue. This data is then translated into medically-detailed natural language for a clinician, enabling a clinician to analyze the patient interview as in step 102. As referred to herein, the “clinician” may be a doctor, a nurse practitioner, or other qualified health professional who is able to analyze the health issue, apply his or her medical judgment to produce an assessment, and suggest treatment and a plan of action for the health issue.

Based on the clinician's expertise and the review of the patient answers to the adaptive interview, the clinician creates a plan of action as in step 103. The plan of action is then transmitted and displayed to the patient in patient-friendly natural language as in step 104, so that the patient can easily understand the healthcare issue and proceed with treatment implementation as in step 105. In the case that the clinician recommends a third party visit with another healthcare provider as in step 106, the relevant recommendations for further action will be performed by the third party as in step 107. The plan of action to address the healthcare issue will then be updated upon completion of the third party activity as in step 108. The plan of action may further be customized to contain multiple third party referrals, including providing an additional third party referral as a result of steps 107 and 108.

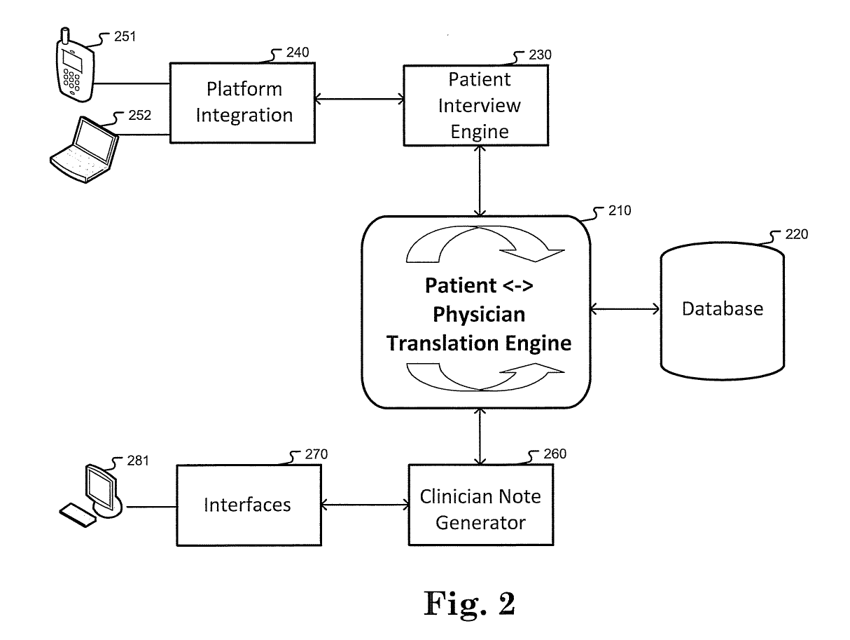

FIG. 2 further depicts a diagram showing the interaction between the various user interaction components of the digital healthcare platform according to one embodiment of the present invention. As shown, at the center of the system is a patient-physician translation engine 210 which makes up a primary component of the “expert system” referred to herein. This engine connects to a database 220 and is used to translate the adaptive interview answers into clinician-detailed text, and translate clinician recommendations into patient-friendly text.

The initial patient interaction with the system is facilitated by the patient interview engine 230 used to generate the adaptive interview. The adaptive interview of the present invention is the most time intensive step for the patient but is highly biased with discrete, limited selection questions. The patient interview is connected with platform integration 240 capabilities enabling use of varied platforms such as mobile devices 251 and other computing devices 252. Such devices may include, without limitation, an iPhone, a smart phone, any mobile digital device, or any mobile or non-mobile electric device configurable to electronically connect to the patient interview system 230 via known wired and wireless network technologies such as TCP/IP protocol and WiFi. Moreover, the patient may use different various mobile devices 251 and other computing devices 252 throughout the session to access and communicate with the system. For example, the patient may complete the patient interview on a desktop computer 252 and, responsive to instructions received from a clinician on the desktop computer, the patient may subsequently use a mobile device 251 to complete a clinic visit as part of the same session with the system. The responses from the patient, and any other available information that will be relevant for the clinician, is transmitted to the patient-physician translation engine 210.

After completion of the patent interview, the clinician interaction with the system is facilitated by the clinician note generator 260. The clinician note is able to provide condensed and medically specific patient data to the clinician to assist with the clinician recommendations. The clinician note is presented to the clinician through use of various interfaces 270 for access on devices such as computing machines 281, and the clinician can use these interfaces to provide eventual recommendations and a plan of action.

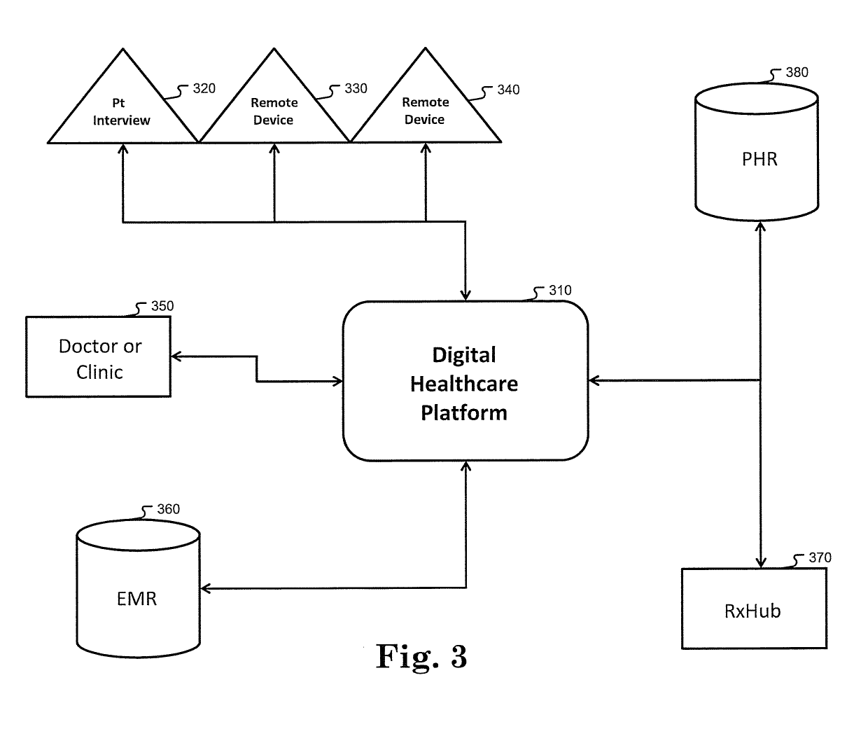

FIG. 3 depicts a diagram showing the interaction between the various data components used in the digital healthcare platform of the present invention. As shown, the digital healthcare platform 310 can be configured to collect data from a variety of sources, including the patient interview 320, remote monitoring devices 330 and 340, a third party doctor or clinic 350, an electronic medical record repository 360, a prescription database 370, or a patient health record database 380. Each of the data sources potentially provide distinct data that can be combined in order to present the most accurate picture of the patient's current condition. For example, remote monitoring devices are useful because they have no bias, are able to perform background or habitual collection, provide sufficient data on a precise patient status, and may be portable.

Each of the data collection activities and results are coordinated through use of an identifier. This identifier is created once the patient begins the healthcare issue resolution process with use of the digital healthcare platform. Additionally, as shown in FIG. 3, data is not only collected from these various sources, but is also passed from the digital healthcare platform to the various databases as information is sent, updated, and managed. The identifier associated with the patient interaction is used to help track and coordinate the updates of information from the interview to the ultimate treatment, even treatment occurring at a third party.

In one embodiment, the data collected from the digital healthcare platform is stored within a database provided by a relational database management system, and likewise data collected from the digital healthcare platform is stored using a series of relational tables within the database. All data transmitted through the system and in interactions with the platform is stored and tracked. Generally, data is codified and used based on a single patient encounter. However, multiple encounters may be connected together either for use in a clinical analysis or for data reporting. Clinician recommendations similarly are stored within the database for each encounter.

Patient Interview

In one embodiment, the primary source for data on the patient's healthcare issue is obtained directly from the patient through use of an adaptive patient interview performed on a mobile device 251 or other computing device 252. The adaptive interview is powered by the patient interview engine 230 and electronically presents a series of questions to the user, each question having discrete answers (i.e., selected from a limited number of choices), with subsequent questions selected and/or modified based on the preceding questions. Questions and answers are structured to be patient-friendly, employing non-physician language that is readily understandable by a layperson.

The patient interview may be performed in an interface accessed by the patient via a website, an application, or other means on a mobile device 251 or other computing device 252. On the mobile device 251, the interface may be presented through a mobile friendly website or a native application for the mobile platform. Within the patient interview, navigation is designed to be intuitive and fast as the patient is quickly guided through an evidence-based, clinical questionnaire. A progress bar may be presented to keep the patient informed of how far along he or she is in the interview process. Answers are automatically saved as the interview progresses.

Further functions available in conjunction with the patient interview include requiring the patient to establish an account before proceeding with analysis of a healthcare issue. For example, an established account may provide a user with a unique username/password to access his or her account and initiate the healthcare interaction. As part of this account, the interface may also require the patient to provide payment information details (such as electronic check information, credit card numbers, insurance plan information, or other payment details).

In one embodiment, the adaptive interview begins by requiring the patient to select a category from a list of predefined categories, which may further include subcategories. The patient will be asked questions to define the precise health care issue. For example, the patient will be asked what are the current symptoms, where the symptoms are occurring, how long the symptoms have occurred, and appropriate follow-up questions.

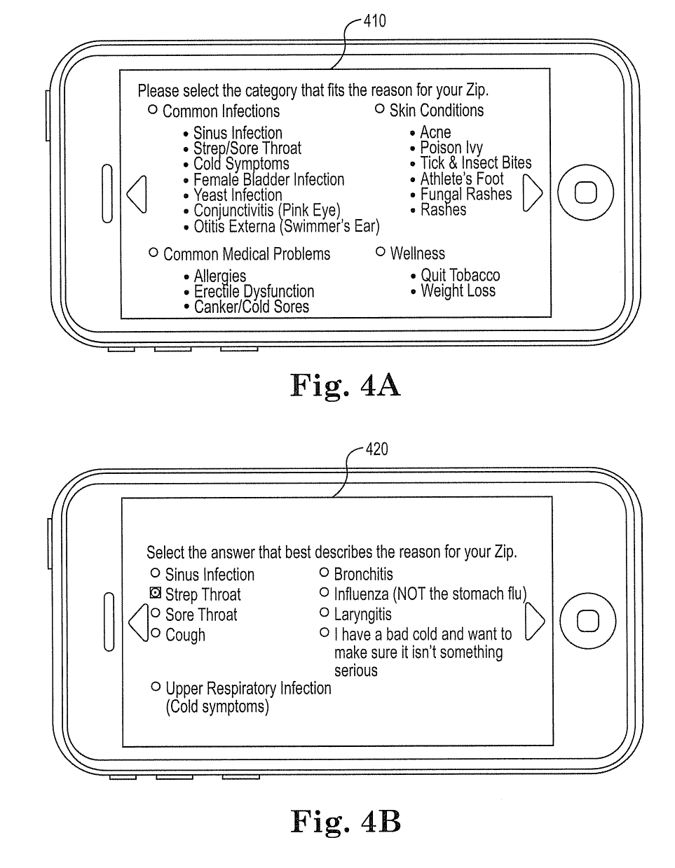

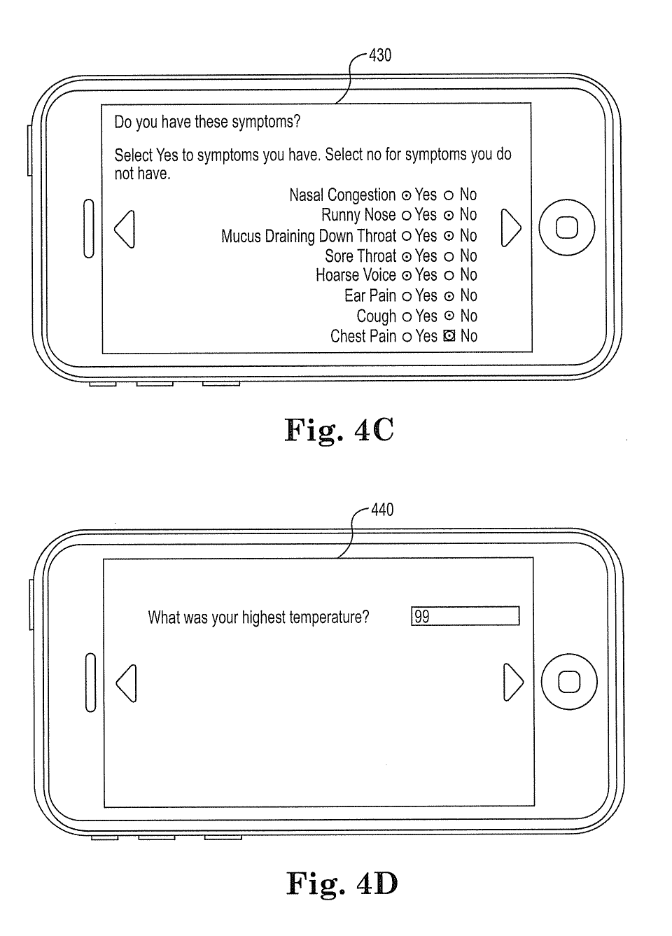

In the following example, the adaptive interview is performed on a mobile device 251, but those skilled in the art will appreciate that numerous other devices may be suitable to perform the interview. FIG. 4A depicts an example adaptive interview interface screenshot 410 that is displayed to the user on mobile device 251, presenting a list of healthcare issue categories. On this screen, the healthcare issue categories correspond to a predefined list such as a retail clinic list of visit reasons. As shown in FIG. 4A, these categories may include “Common Infections”, “Common Medical Problems”, “Skin Conditions”, and “Wellness,” and are displayed within the adaptive interview user interface.

FIG. 4B depicts an example adaptive interview interface screenshot 420 displayed to the user presenting a follow-up question responsive to a user selecting the “Common Infections” category from the options displayed on screenshot 410 and then selecting a subcategory to further refine the interview information. Additional embodiments of the invention provide for classification of healthcare issues by specialty during the adaptive interview, such as classification within a set of ear-nose-throat conditions or a general family practice condition.

Throughout the adaptive interview, the expert system analyzes the combination of answers to determine if additional or follow-up questions should be asked. The patient adaptive interview is structured to use branching logic to determine the order and content of the various follow-up questions. Likewise, the various order and content of the follow-up questions is determined by the previous answers. If the patient navigates to an earlier answered question and provides a different answer, different follow-up questions will be asked.

As shown in FIG. 4B, the patient has selected a suspected “Strep Throat” healthcare issue as the reason for initiating the healthcare interaction. The next interface screenshot 430 that is displayed to the user, FIG. 4C, will request additional information about the specific symptoms the patient is undergoing, to confirm or eliminate an assessment, which in this example is strep throat. Although this example presents a case of the patient generally knowing or suspecting his or her particular health issue and navigating in the adaptive interview to confirm specific symptoms, the same result may be reached by generally querying patient symptoms followed by specific questions to determine an unknown health issue.

FIG. 4D shows a patient data input screenshot 440 within the adaptive interview that is displayed to the user and used to ask the patient a specific question about a healthcare parameter, in this case, the patient's internal body temperature. In this example, the patient can enter his or her highest known temperature measurement within the interface. Likewise, other types of relevant medical monitoring values such as blood pressure, pulse rate, glucose level, and the like may be collected from the user. Further embodiments of the present invention discussed herein include functionality to receive a manual or automated collection of data from external medical monitoring apparatuses, such as medical monitoring devices or peripherals connected directly to the mobile device.

If, during the adaptive interview process, the expert system recognizes that the patient provides an answer suggesting a time-sensitive or serious medical issue that may be better addressed by treatment scenarios other than the digital healthcare platform, then a message is displayed to seek more immediate medical help. If the symptoms and adaptive interview questions appear to be within the scope of treatment offered by the healthcare platform, then the completed adaptive interview is sent to a clinician for assessment. The following section discusses the role of assessment by a clinician and the creation of a healthcare plan of action within the digital healthcare platform.

Clinician Assessment of the Patient Healthcare Issue

As used herein, a “clinician” refers to a specific medical professional who uses the digital healthcare platform, usually from a location remote to that of the patient/user who completed the electronic interview, to provide a plan of action for the patient to address the patient's healthcare issue. The clinician is typically a doctor who has contracted with the digital healthcare platform service to review patient interactions (i.e., the patient adaptive interview and medical history information) within the digital healthcare platform. Those skilled in the art will recognize that the clinician involved may be a doctor, a specialist, a general practitioner, a nurse practitioner, or like skilled medical professional. Additionally, the clinician may be selected from a pool of available clinicians, or may be specifically selected by operators of the digital healthcare platform service or by the patient themselves.

In one embodiment of the present invention, after review of the patient's interaction with the digital healthcare platform, the clinician will determine one or more of the following outcomes to address the patient's digital healthcare platform interaction:

1. Provide specific recommendations for the patient and a general plan of action. For example, for the treatment of a mild cold, the instructions would include having the patient drink fluids, get rest, take over-the-counter pain relief, etc.

2. Prescribe a drug and treatment plan. This determination would be followed by issuance of a prescription from the clinician along with drug instructions.

3. Instruct the patient to visit a third party medical provider for further screening, tests, or evaluation.

In one embodiment, although the digital healthcare platform expert system is extensively involved in collecting and streamlining data to address the healthcare issue, the clinician makes the ultimate medical decisions and recommends the final plan of action for the patient. The digital healthcare platform therefore serves a significant role for collecting and organizing medical information efficiently for the clinician, but it remains the clinician's responsibility to treat the patient correctly.

The clinician interacts with the digital healthcare platform through computing machine 281 which displays content and interactive displays through clinician note generator 260 and interfaces 270. In various embodiments of the present invention, the clinician is presented with a set of one or more user interfaces to create and manage an assessment of the healthcare issue and a treatment plan of action for the patient. Similar to the patient interface, the clinician interface may be presented on computing machine 281 in a website or as a stand-alone application. Further, clinicians may be presented with a predecessor interface to view and manage multiple action items received from a plurality of patients. The clinician interface may also be username and password protected, or otherwise require clinician authentication.

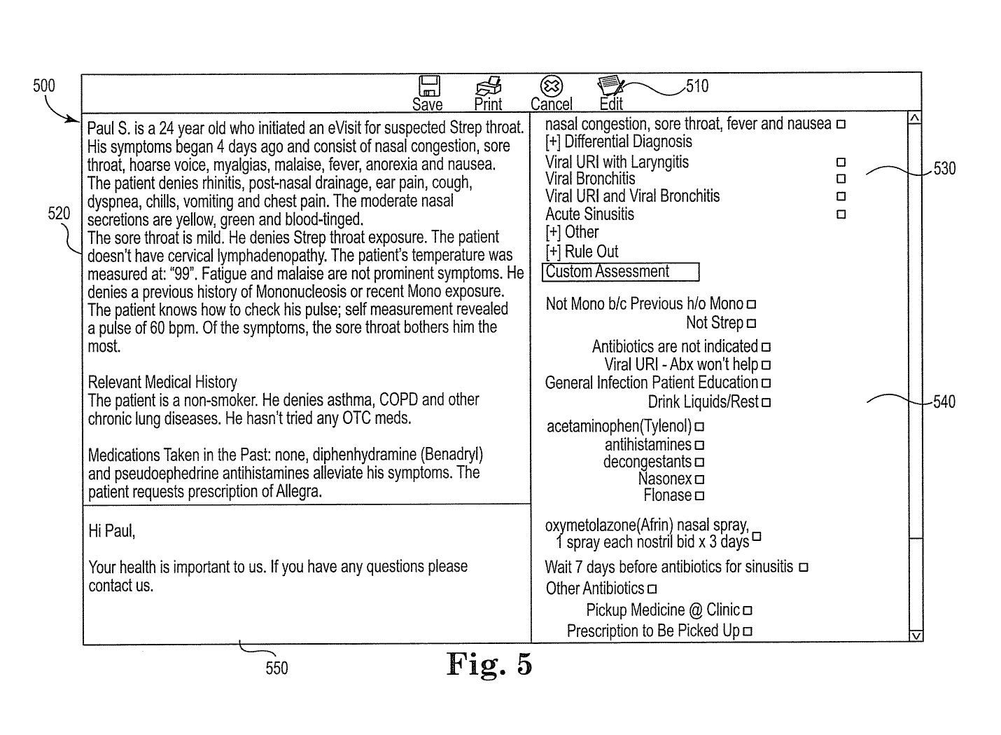

FIG. 5 depicts a screenshot 500 on computing machine 281 of a sample user interface 500 used by a clinician in the digital healthcare platform to create a health care assessment and a plan of action for the patient's healthcare issue. The sections of this interface include interface navigation 510 (such as save/print/edit/cancel functions), a Clinical Note section 520, an editable Assessment section 530, an editable Plan of Action section 540, and an editable Patient Recommendation Text section 550.

Using the patient-physician translation engine 210, the clinician note generator 260 of the expert system automatically generates and displays Clinical Note section 520 based on the patient's answers to questions. The digital healthcare platform expert system applies a proprietary scoring system to the patient interview intake information and thereby determines the most probable assessment(s) of the patient's healthcare issue. Based on the determination of most probably assessments, the expert system automatically generates and displays the Assessment section 530 and pre-selects the most likely assessment. Clinicians are required to review the assessment and can easily change any part of the Patient Text section 550 or the Assessment section 530 as needed.

Content and available choices within the Plan of Action section 540 are automatically generated and filtered using expert system analysis of a combination of patient answers, medical history, and standard medical protocols. The expert system thereby suggests a probable plan of action for the clinician's review. As the clinician selects items and creates the plan of action, the steps within the plan of action are automatically and electronically translated back into corresponding patient-friendly language in the Patient Recommendation Text section 550 by employing the patient-physician translation engine 210. Additionally, the plan of action may present functionality to order a prescription and/or refer a patient to a third party medical provider for further action, such as for further testing or an office visit.

The following text describes the operation of each of the clinician interface sections.

Clinician Interface: Clinical Note

A clinical note/report is automatically and electronically created by the expert system for the clinician to review in the Clinical Note section 520 in FIG. 5. The expert system operates to translate the patient answers of the adaptive interview into natural medical language with correct punctuation, grammar, and spelling.

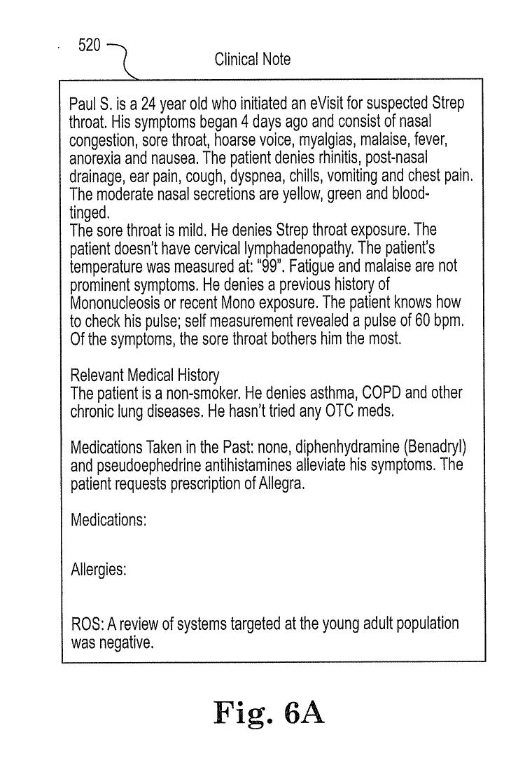

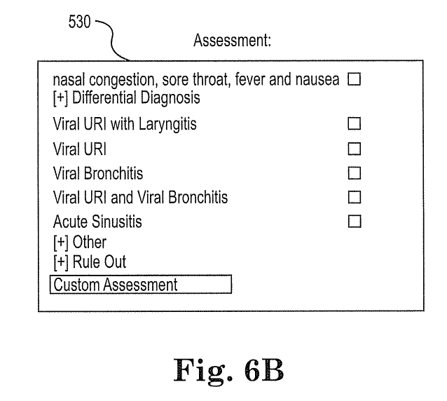

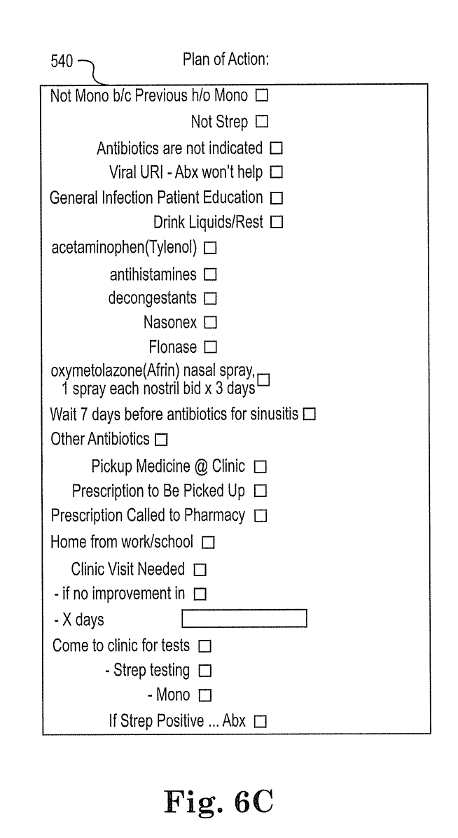

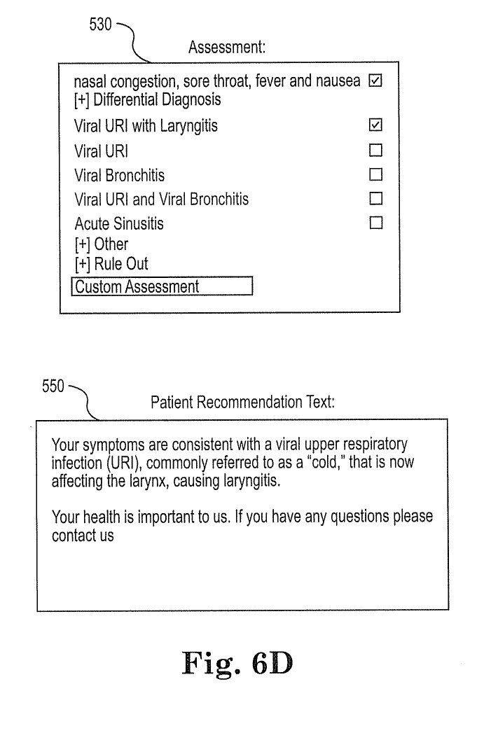

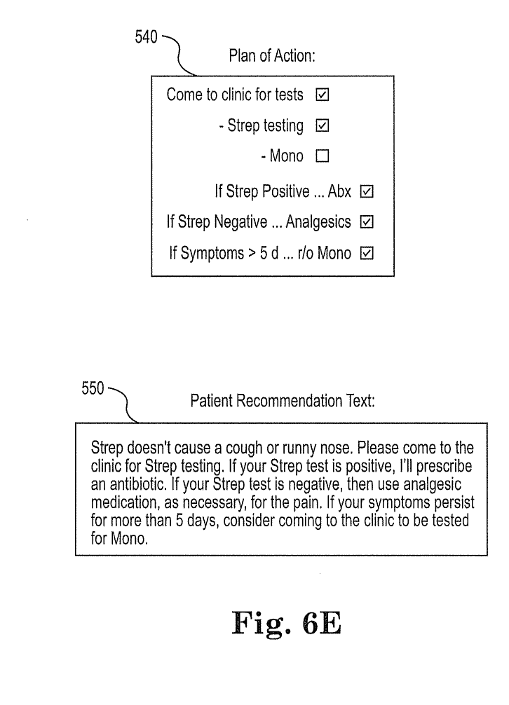

FIG. 6A presents an example of clinician text 520 presented in a clinical report on computing machine 281. In this example, “Paul S.” is the patient's name. The first line of text corresponds to the first selections in the patient interview where the patient selected “Strep Throat.” The selections made by the patient during the interview are transformed into the text as “<patient name> is a <patient_age> who initiated an e-Visit for <Strep_throat>.

The expert system operates to retrieve values from the database for both demographic information (such as gender and age) and for information collected during the interview (reason for visit, specific symptoms, etc.). The expert system combines those values with hard-coded text (e.g., “who initiated an e-Visit for”) and grammatical logic (capitalize “His symptoms”) to provide easily understood and clinically accurate natural language text.

The next lines combine the answers to multiple patient questions about duration of symptoms and the nature of those symptoms into a single sentence for the clinician to review. For example, the logical structure may be structured as: <pronoun> symptoms began <answer_to_symptom_duration_question> and consist of <answers_to_symptoms_questions>.

Using the expert system in this way, the digital healthcare platform converts raw data points into natural language for the clinician to quickly review. The data may also be dispersed into different sections of the clinical note, with customized text formatting (such as different font weights, color, etc.).

In further embodiments, the patient's medical, social, and family history is also presented to the clinician reviewing the note within the clinical text. This additional information may include data retrieved from electronic medical records or other patient healthcare profiles. Other relevant information that may be displayed to the clinician includes information relating to the patient's current medications, allergies and any lab work or remote monitoring results relevant to the healthcare issue.

The clinician interface enables clinicians to quickly scan the synopsis, arrive at their own assessment, check it against the expert system suggestion, and formulate a treatment plan. In one embodiment of the present invention, the entire process of reaching the treatment plan will take no more than 4 minutes for standard cases. However, non-standard cases may take more time or less as is appropriate.

Clinician Interface: Assessment The Assessment section 530 in FIG. 5 provides a clinically accurate assessment of the patient's healthcare issue that can be used in the digital healthcare platform treatment, education, and further action by the patient. An “assessment,” as the term is used herein, is broader than a single medical diagnosis, and an “assessment” is structured to enable the clinician to define multiple aspects of the healthcare issue, including further analysis on potential conditions, and ruling out one or more conditions.

FIG. 6B presents the Assessment section 530 for a patient health issue. The assessment choices that are displayed therein are tied directly to the answers given by the patient, as determined by the expert system. The first selection is a shortcut that allows the doctor to quickly select and confirm the fact that the patient noted nasal congestion, sore throat, etc., in their interview. If the patient had not noted these symptoms, this option and the other assessment options would be different and would correspond to the symptoms identified by the patient.

In this embodiment, the expert system first scores the potential assessment values and then displays them to the clinician in a list in the Assessment section 530. In the current example, from this list the most probable assessment for this patient is “Viral URI w/Laryngitis,” and therefore “Viral URI w/Laryngitis” is displayed prominently in the potential assessment list. This is because based on symptoms noted by the patient in this example the “Viral URI w/Laryngitis” assessment received the highest score by the expert system.

In one embodiment, the expert system scoring system is pre-calibrated by medical experts before it is used in the digital healthcare platform of the present invention. When a series of questions is added to the digital healthcare platform interview, an answer can be labeled as providing a numeric increment or decrement towards a possible assessment. For example, if the patient chooses “No” to nausea when asked questions about strep throat, the strep assessment will be decremented points because this symptom is a contraindication to strep.

After the clinician selects the assessment, specific text corresponding to the clinician's selection is automatically generated in the patient recommendation text section 550 for the patient to review (e.g., YOU have strep throat). The system notes the clinical designation (strep) and stores that as part of the record as well. In this way, there are two results of the assessment selection—information and text that is transmitted and displayed to the patient and the specific selection made by the clinician—that are stored with the record.

Further embodiments also enable a clinician to provide an assessment that will not appear in the patient recommendation text. This enables a clinician to create a custom assessment, which will not be directly transmitted to the patient, and refer back to the custom assessment later if he or she needs to re-evaluate the patient. For example, the physician might make an assessment of both sore throat and r/o (rule out) strep throat. Only r/o strep is transmitted and displayed to the patient, but the doctor can provide the additional assessment of sore throat to remember exactly the key symptoms of the case.

Clinician Interface: Plan of Action Generation

The Plan of Action section 540 of the clinician interface of FIG. 5 enables the clinician to select appropriate tests, actions, and instructions to address the healthcare issue and the various items found in the assessment. FIG. 6C shows plan of action choices 540 that address a patient health issue.

The initial choices that the expert system displays in the Plan of Action section 540 are based on the selections made by the patient and internal logic of the expert system. These plan items include providing patient education text and explanation of the healthcare issue the patient is experiencing, recommending over-the-counter medications, prescribing prescription medications, and ordering tests and follow-up care at a third party medical provider. Plan items may also be created to recommend additional action to be taken by the patient or another clinician at a future time.

Additionally, the clinician assessment and plan of action choices are correlated to a patient identifier in order to properly refer a patient to appropriate follow-up care. For example, if the clinician selects “Come to the clinic for tests” and then selects “Strep Testing,” this will trigger a new identifier associated with the strep test to be performed. As later described in this disclosure, the patient will present this identifier to a third party medical provider to perform the appropriate follow-up action, here a strep test. In this way, the online clinical plan of action determined by the clinician is correlated to an action to be actually performed by or on the patient, such as a strep test in a third party clinic when the patient ultimately visits the clinic.

As previously described, the clinician interface contains an Assessment section 530, which is editable and updatable by the clinician, listing the most probable assessment of the healthcare issue, and separate action items in the Plan of Action section 540 that identifies and establishes treatment and other future actions. As the clinician selects the most relevant treatment assessment for the healthcare issue in the Assessment section 530, the displayed Plan of Action section 540 is immediately and automatically updated accordingly by the expert system.

Further embodiments of the plan of action also include providing support for the clinician to issue prescriptions. Upon receiving instructions electronically from the clinician, the digital healthcare platform automatically routes prescriptions to specific pharmacies based on patient preferences. The platform may transmit the prescriptions via e-faxing functions, Internet or other networking technologies, or any other suitable means for delivering a prescription to a pharmacy. The particular pharmacy to which the prescription is directed may be selected through a variety of means as described in more detail herein. Because the digital healthcare platform issues the prescription automatically via fax or other electronic methods, the prescription is secure and generated automatically based on clinician choices.

If the plan of action is overly complicated or the clinician determines that the healthcare issue cannot be best addressed with care achievable through the digital healthcare platform, then the plan of action is cancelled and the patient will be instructed to seek further appropriate care. In such scenarios, the plan may be cancelled automatically by the digital healthcare platform upon triggering one or more rules applied by the platform to determine particular situations in which the patient shall be instructed to seek further care, or the plan may be cancelled by the clinician upon his or her determination that seeking further care is the appropriate course of action. Otherwise, the plan of action completed by the clinician will be electronically transmitted to the patient (such as via mobile device 251) and will direct the patient to perform the plan of action and obtain the next stage of care.

Clinician Interface: Patient Friendly Text

As shown in FIG. 5, the Patient Recommendation Text section 550 of the clinician interface automatically and dynamically displays appropriate text responsive to changes made by the clinician elsewhere on the clinician interface 500. This enables the clinician to readily generate and edit instructions to address patients' outstanding healthcare issues. The Patient Recommendation Text provides a set of instructions for the patient to perform the recommended plan of action advised by the clinician. The Patient Recommendation Text also explains to the patient the patient's current assessment and other relevant information about the healthcare issue. The patient-physician translation engine 210 of expert system of the digital healthcare platform operates to generate the text of the Patient Recommendation Text section 550 immediately as the clinician enters his or her selections in both the Assessment section 530 and the Plan of Action section 540. Further, the patient-physician translation engine 210 immediately updates and modifies the text of the Patient Recommendation Text section 550 responsive to the clinician entering changes in either the Assessment section 530 or the Plan of Action section 540.

In one example of the present invention, FIG. 6D illustrates the simultaneous screenshots of the Assessment section 530 and the corresponding Patient Recommendation Text 550 sections. The first Assessment 530, which was generated and suggested by the patient-physician translation engine 210 of the expert system based on the results of the adaptive interview, is “nasal congestion, sore throat, fever and nausea.” Also shown in FIG. 6D is the clinician's selection of the assessment of “Viral URI w/Laryngitis” by checking this box. Immediately responsive to the clinician's selection in the Assessment section 530, new text suggested by the patient-physician translation engine 210 is generated and inserted in the Patient Recommendation Text section 550 for the patient, explaining the assessment from the clinician. The inserted text is automatically highlighted, as in FIG. 6D, and such highlighting serves to identify for the clinician what text was added in response to this action. The patient-physician translation engine 210 thereby enables the clinician to transform a clinical assessment into patient text in real-time with a single action. The text inserted in the Patient Recommendation Text section 550 by the patient-physician translation engine 210 is reviewable and editable by the clinician before it is transmitted to the patient. This function allows the clinician to ensure that the text is accurate for the situation and allows the clinician to enter any edits or additional comments he wishes to implement before the Patient Recommendation Text is sent to the patient.

In another illustrative example, the Patient Recommendation Text section may provide additional content, including patient education and explanation. For example, responsive to the clinician's selection of the “Not Strep” box in the Assessment section 530, the patient-physician translation engine 210 immediately generates and inserts highlighted text in the Patient Recommendation Text section 550 to the patient explaining why he or she does not have strep throat, and why their symptoms are inconsistent with this assessment. As previously described, the inserted text is then reviewable and editable by the clinician before it is transmitted to the patient. Additionally, responsive to the various selections by the clinician and/or the expert system, the patient-physician translation engine 210 immediately generates links to patient education materials (such as videos, brochures, etc.) that the patient may then select and review. In further embodiments, such education materials are tied to the “Not Strep” database entry such that the expert system automatically displays the correct educational video(s) or content.

A yet another example, FIG. 6E shows a Plan of Action section 540 with selections implemented by the clinician. In this example, the clinician requests that the patient to physically visit a third party clinic for strep tests by selecting “Come to clinic for tests” and “Strep Testing” in the Plan of Action section 540. Immediately responsive to the clinician's selection in the Plan of Action section 540, new text suggested by the patient-physician translation engine 210 is generated and inserted in the Patient Recommendation Text section 550, shown in FIG. 6E, requesting that the patient come to the clinic for strep testing. The clinician may also select additional options presented by the expert system that may be appropriate when strep throat is suspected and the clinician has requested a step test. For example, the clinician may decide to not request a mono test at that time but rather the clinician additionally selects the option “If Symptoms>5 d . . . r/o Mono”, meaning if the symptoms last for more than 5 days, then Mono needs to be ruled out. Again, immediately responsive to the clinician's selection in the Plan of Action section 540, new text suggested by the patient-physician translation engine 210 is generated and inserted in the Patient Recommendation Text section 550. The inserted text is highlighted in FIG. 6E, which also serves to identify for the clinician what text was newly added in response to this action. The text inserted in the Patient Recommendation Text section 550 by the patient-physician translation engine 210 is then reviewable and editable by the clinician before it is transmitted to the patient. This serves to ultimately provide an order for the third-party clinic staff based on the results of the test.

In the foregoing example, the digital healthcare platform provides an efficient patient-physician interface, which streamlines communications and assessments with the patient-physician translation engine 210, and results in the electronic creation of a clinician Assessment and Plan of Action. Upon completion of the adaptive interview, Assessment, and Plan of Action, the generated Patient Recommendation Text, which conveys the clinician's Assessment and Plan of Action, is electronically transmitted by the digital healthcare platform to the patient at a location such as the patient's mobile device 251 or the patient's computing platform 252. In this example of generating a strep test item for the Plan of Action, the following steps are performed by the digital healthcare platform through use of the patient-physician translation engine 210 and the clinician note generator 260:

1. Patient Instructions, generated and edited through use of the Patient Recommendation Text section 550, are transmitted to the user's mobile device 251 from the digital healthcare platform, and include instructions to visit the clinic for a strep test.

2. The digital healthcare platform generates an electronic “Ticket” containing a globally unique identifier (GUID). The Ticket is unique to both the patient and the particular platform session that is executed for addressing the patient's health issue. The Ticket then can be transmitted to the patient's mobile device 251, or alternately the patient can download his or her Ticket to a location such as the patient's mobile device 251 or the patient's computing platform 252.

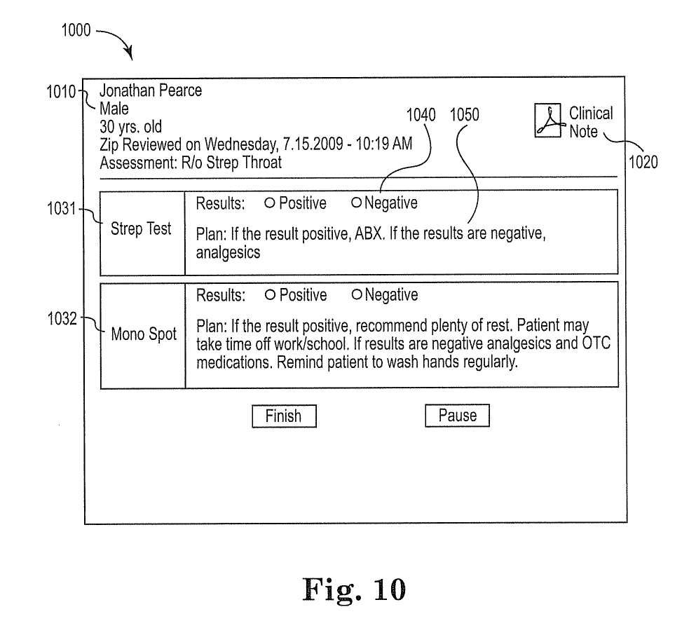

3. A data interface for a third party doctor, clinic, or other medical provider 350 is established. The patient arrives at the third party medical provider 350 and presents the provider with the Ticket, as described in more detail herein. The third party medical provider 350 uses the Ticket to retrieve the patient's health record from the digital healthcare platform, and the health record includes an instruction to conduct a strep test (Positive or Negative) and directions instructing: if negative, provide analgesics; if positive, provide antibiotics. The data interface for the third party doctor, clinic, or other medical provider 350 displays selections for the provider to enter the test result, which is then transmitted back to the digital healthcare platform. An example of the third party medical provider instructions and responses are shown in FIG. 10 where the clinician's instructions include a strep test. This interface serves as an order for the third party medical provider to perform a certain action (here, a strep test) that was determined by the clinician.

4. A follow-up item may be created in the digital healthcare platform when appropriate to address a plan of action item for the future. In this example, if the patient's throat symptoms are not better in 5 days, the follow-up item directs the provider to perform a monospot test to rule out mono. A message containing the follow-up item may be automatically sent to the patient on mobile device 251 or to the clinician on computing machine 281 as a reminder to follow up with the patient. When the patient arrives at the third party medical provider to have the additional testing performed, the follow-up item is displayed on the third party medical provider's interface to provide the appropriate instructions for the testing. The multiple tests, which in this case are a strep test and a monospot test, may be performed by different third party medical providers if such an arrangement is most convenient for the patient. Accordingly, the second or any subsequent instructions for testing may be sent to a different provider than the first instructions for testing.

5. Finally, upon completion of all necessary testing and other steps for diagnosis and treatment for the patient's health issue, text is generated for the formal clinical note once the issue is fully resolved by the patient. In one embodiment, the formal clinical note is generated into a locked-down, security protected PDF file, and is generated at the end of the patient encounter or session. Additionally, the digital healthcare platform facilitates use of a “working” clinical note to enable a clinician and third parties to store their assessments, plan of action, notes, etc. in the same PDF file before the file is locked down.

Patient Interaction with Clinician-Recommended Plan of Action

After the clinician has completed his or her assessment of the patient's healthcare issue and recommended a plan of action, the patient will be notified with the assessment and plan of action. This is typically provided in the form of the clinician-edited patient instructions that are derived from the Patient Recommendation Text section 550, and are electronically transmitted to the user on the mobile device 251 or other computing device 252. In one embodiment, the patient retrieves these instructions by using either of devices 251/252 to return to the user interface of the digital healthcare platform and view the status of any outstanding healthcare issues. In further embodiments, a notification message is sent to the user upon completion of clinician review. The notification message may be sent via the SMS protocol to the mobile device 251 on mobile or telephony networks.

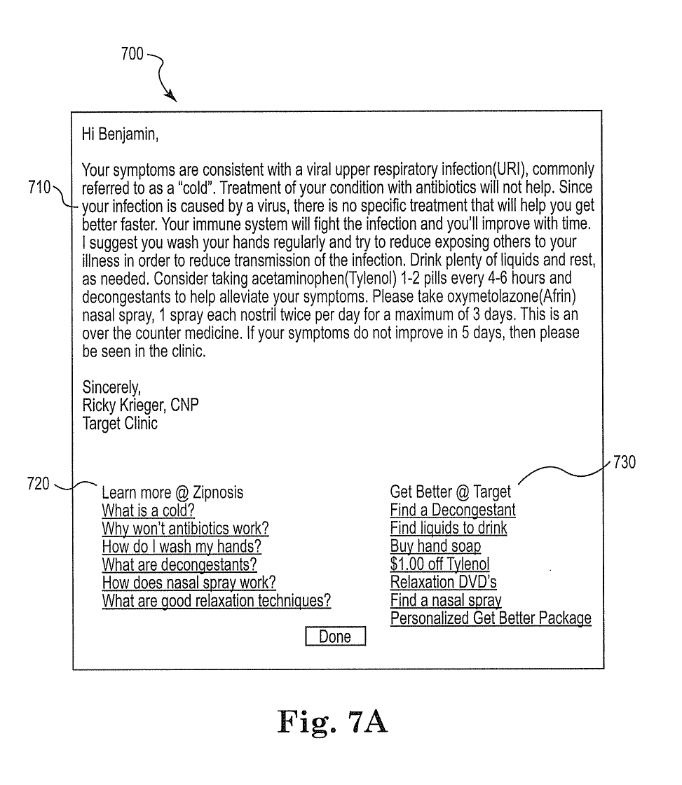

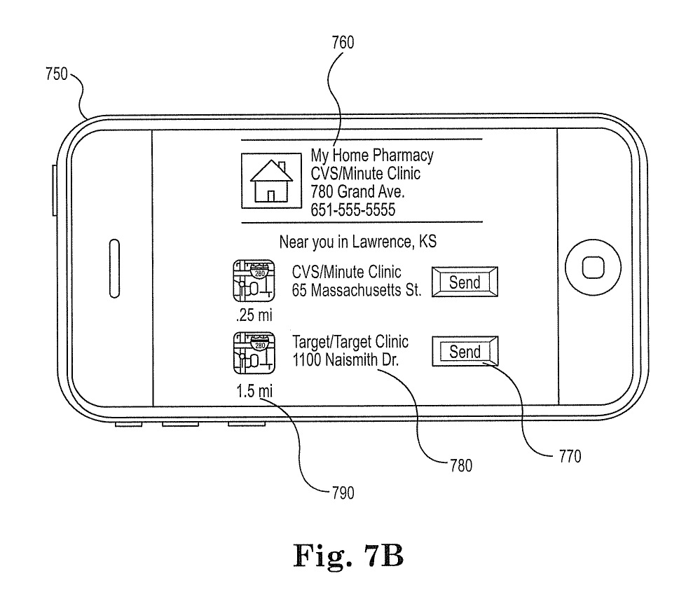

FIG. 7A displays a sample interface displayed on mobile device 251 for a patient to review the status of an outstanding healthcare issue. The interface 700 displays the patient friendly text 710 having instructions and explanations provided from the clinician. This may include recommendations for over-the-counter drugs and remedies, or instructions related to prescription medicines. In one embodiment, patients can access interface 700 via a web browser, smartphone, or any other suitable interface operable on a mobile device or other computing device.

The interface 700 enables the patient to follow up and view the status of the healthcare issue and the e-Visit at a convenient time for the patient. The interface 700 also provides a unified location for patients to view current Tickets (i.e., referrals to third party medical services) and to download, print, or send the Tickets. Further embodiments of the interface 700 may also include providing direct access to the patient's personal electronic health record.

The interface 700 also provides a location for advertising, coupons, education, and other relevant materials secondary to the patient care instructions. For example, the digital healthcare platform may automatically determine corresponding information that is related to the patient's session and then display the relevant patient education information and materials to the patient on interface section 720. Such information and materials may be provided directly within the user interface or indirectly by hyperlinks to a website.

Additionally, a listing of coupons or promotions relevant to the patient's healthcare issue may be displayed to the user in section 730 of the patient interface 700. In one embodiment, coupons are presented as links, and each coupon has valid redemption locations and an expiration date as determined by the issuing party. For example, the patient may obtain or redeem over-the-counter remedy coupons by downloading the coupon as a PDF to print, or the patient may directly download/send the coupon to a mobile device to be scanned at the point of sale. Interface section 730 may also provide other related advertising links. For example, in a further embodiment, the digital healthcare platform integrates keywords from retailers (such as mass-merchandisers or drug stores) to offer advertisements and coupons for relevant over-the-counter products. Unlike search engine keywords, the keywords generated within the digital healthcare platform derive from recommendation text from a clinician and thus are far more relevant, accurate, and focused to the specific healthcare issue.

In situations where the clinician issues a prescription for the patient via the digital healthcare platform, then the patient interface 700 can list all active prescriptions and enable the patient to select a desired pharmacy for fulfilling and dispensing the prescription. For example, upon determining that the clinician is writing a prescription for a patient, the digital healthcare platform will generated a list of suggested pharmacies for fulfillment of that prescription based on the patient's stored preferences, the patient's known location, or other suitable information. FIG. 7B illustrates one example of an interface 760 operating on a mobile device 251 (specifically, smartphone 750) allowing a patient to send 770 the prescription received from the clinician to a pharmacy selected by the patient from a list 780 of suggested pharmacies. Further embodiments may also utilize functions of GPS and/or Mapping Services (such as Google Maps API) to provide maps and/or directions 790. For example, where the patient's mobile device 251 or other computing device 252 is GPS-enabled, the device transmits its current GPS coordinates to the digital healthcare platform, which in turn determines and identifies the closest pharmacies to the GPS coordinates. The digital healthcare platform suggests the identified pharmacies to the patient for fulfillment of the prescription, and the list 780 is displayed to the patient on interface 760. The patient then selects the desired pharmacy from list 780 and optionally selects directions to the pharmacy from the user's current location as defined by the GPS coordinates. Upon selection of the pharmacy location, the digital healthcare platform transmits the prescription to the correct pharmacy electronically or via faxing services.

The patient user interface 700 may also provide a listing of all active healthcare issues for a patient, and all valid Tickets for use at third party healthcare providers. As discussed in the following section, each Ticket has a list of valid locations for its use and an expiration date. User interface 700 may also be adapted to provide a listing of relevant third party locations for use of the Ticket and additional treatment. Further, the interface may also provide links to directions of the valid clinics or third party medical providers accepting the Ticket. Still further, the interface may enable directions or maps to the service, such as via web links, text messaging, or a native mobile application in the mobile device.

As described above, on the interface 700 the patient may select display of the healthcare Ticket, which was generated along with the patient instructions. Within this interface, the user may select to print the Ticket (for example, by creating a PDF ticket barcode that can be downloaded and printed by the patient), or send the Ticket to the patient's mobile device. The interface allows the patient to print and resend the Ticket at any time until the Ticket expires. The following section describes the transmission and use of the healthcare Ticket at third party healthcare service providers.

Further Steps: Receiving and Using a Healthcare “Ticket”

When the plan of action developed by the clinician includes a recommendation for the patient to obtain third party services for addressing the healthcare issue, the digital healthcare platform generates an electronic Ticket which includes a GUID or other unique identifier, and transmits the electronic Ticket to the patient. The digital healthcare platform electronically stores the Ticket and the GUID or other unique identifier, and theses items are electronically associated with the clinical note from the patent's e-Visit within the digital healthcare platform. The Ticket is then available for future retrieval, enabling its use as a “boarding pass” for patients to be received into a clinic, testing center, or other third party medical provider.

The Ticket expedites the patient's visit to the third party clinic or other provider by eliminating redundant paper work and intake procedures that would otherwise be necessary at the third party provider. The Ticket's unique identifier allows the assessment and plan of action made remotely by the clinician to be accessed electronically to the third party clinic immediately so that the clinic's administrative staff knows which lab tests were recommended for the patient and will be performed. Further, upon completion of the test, the third party clinic may immediately transmit the results to the digital healthcare platform, which in turn records the results received by the clinic in the same clinical note or record, thereby allowing the clinician to view the test results, rule out various conditions, and confirm the proper plan of action and treatment for the patient based on the results. The Ticket's unique identifier also associates online health and consumer activities to physical locations, and enables the digital healthcare platform to serve as a triage tool for clinics and other third party centers without requiring an initial clinic visit.

As previously described, the Ticket may be generated by the digital healthcare platform in more than one manner. In one embodiment, the Ticket is generated automatically by the digital healthcare platform responsive to specific selections made by the clinician within the digital healthcare platform and interfaces. For example, when the clinician selects certain predetermined assessment items in the Assessment section 530 of the user interface 500, the digital healthcare platform will generate a Ticket. Selection options in the Assessment section 530 such as strep test, monospot, and physical evaluation, may be predetermined or flagged to trigger a Ticket generation upon selection by the clinician. When a clinician selects such a predetermined item, a Ticket having a unique identifier is created within the digital healthcare platform, and a flag is set to display a link to download/send a barcode or other means for conveying the Ticket.

Alternatively, the digital healthcare platform may generate a Ticket in response to a clinician's selection of a predefined healthcare issue. For example, the digital healthcare platform may automatically generate a Ticket if the clinician assesses that the patient has specific symptoms or if a specific medical problem appears to be implicated and the clinician accordingly selects a corresponding healthcare assessment.

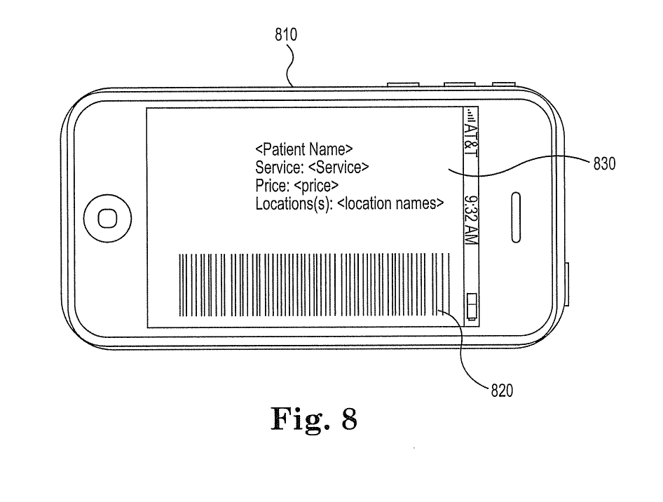

In one example, a patient arrives at a third party clinic or other third party medical provider as a result of receiving patient recommendation text from the clinician that advises a visit to such a clinic. Upon arriving at the front desk of the clinic, testing center, or other medical provider, the consumer retrieves the Ticket on the mobile device 251 and presents the Ticket to the provider by displaying the Ticket directly on the screen of mobile device. FIG. 8 depicts an example of a barcode Ticket 820 displayed on a patient's mobile device 251, illustrated as a smartphone 810. Alternatively, the patient may print the Ticket and present the paper copy of the Ticket to the clinic staff.

In one embodiment, each Ticket, whether printed or electronic, lists relevant information 830 such as a price of the service and valid locations for service. In the case that the information cannot be displayed directly on the Ticket, the information may be included via the patient interface or via a text message or e-mail sent to the patient. Within the text message or e-mail is either a link to the barcode or an image of the barcode directly.

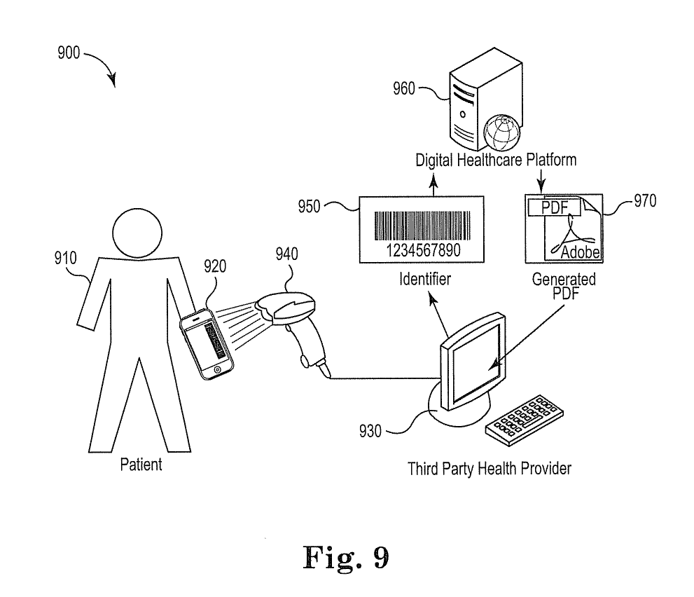

FIG. 9 depicts one embodiment of a summarized scenario 900 for a patient receiving and using a barcode Ticket at a third party healthcare provider presented via a mobile device.

1. A patient 910 conducts an e-Visit with the digital healthcare platform 960 as previously described. After the clinician reviews the patient's interview and creates clinician-edited patient instructions, which are derived from the clinician's assessment and plan of action, the patient instructions are electronically transmitted to the patient (such as via email or text message) and displayed on the mobile device 920. The patient instructions may indicate that the patient requires additional tests or evaluation.

2. The patient 910 receives or accesses with his or her mobile device 920 a barcoded Ticket that encodes a unique identifier that is associated with his or her e-Visit information, identity, and time-stamps for reasonable expiration.

3. The patient then identifies on the mobile device 920 a conveniently located “Ticket-enabled” third party medical provider to address the additional test or evaluation. The patient makes this selection on the mobile device 920 from a displayed list of proposed providers that are filtered by proximity to the patient, ability to perform the necessary tests or evaluations, and patient preferences. The selected provider may be a local primary care doctor, a quick service clinic, a specific testing center, or other suitable entity or person.

4. The patient physically visits the selected third party health provider 930 and presents to the provider a paper copy of the Ticket or an electronic copy of the Ticket displayed on the screen of mobile device 920. The third party health provider 930 scans the Ticket on the mobile device 920 with a scanner 940 to read the barcode identifier 950 on the Ticket. The third party's scanner 940 is electronically connected to a computer system configured to run an interface and application that receives and decodes the information scanned from the Ticket. The computer system application communicates with the digital healthcare platform 960 via a network connection and transmits the barcode identifier 950 to the digital healthcare platform 960.

5. In response to receiving the patient's barcode identifier 950 from the third party health provider 930, the digital healthcare platform 960 retrieves and transmits relevant information to the third party health provider 930. In one embodiment of the invention, the information is collected and transmitted in a generated PDF 970 file. The information transmitted to the third party health provider 930, whether it is stored in a PDF file or other suitable structure, includes the patient's medical record and the interaction of the e-Visit relevant to the healthcare issue, including the adaptive interview results, the clinician assessment, the plan of action including any tests or evaluations ordered by the clinician, and any clinician notes.

When the Ticket barcode is scanned at the third party health provider 930, the provider will be instructed via the interface to pull up the appropriate record/information. The clinic staff thereby receives instructions for what action to take for the patient, for example performing a strep test to printing the H&P previously taken online so the physician does not have to repeat the process.

In additional to retail clinics or nurse line settings, the Ticket also provides mobility to the digital healthcare platform assessment, providing the flexibility to be used at any Ticket-enabled medical provider selected by the patient. The digital healthcare platform manages and facilitates financial processing and auditing of the transactions, thereby reducing consumer interactions with third party health providers and ensuring the consumer has the lowest possible cost care. This provides convenience and compliance for both the patient and the healthcare provider.

The previously described scenario is applicable to a number of patient types and healthcare settings. For example, the mobile Ticket model works efficiently with students at a college, with employees at a large employer, and in other large group settings. The use of the Ticket to access information with the digital healthcare platform provides patients with the flexibility of either visiting a local clinic (such as a campus or workplace clinic) or to other clinics in more convenient locations close to work or home. Further, each Ticket may be configured independent of a clinic, which provides the ability to assign a single Ticket type to multiple clinics and provide location convenience.

The barcode Ticket is primarily used to provide a unique number that will identify relevant records in the digital healthcare platform. There is no patient-identifying information directly contained in the barcode, and the barcode data is irrelevant if not accessed within the correct digital healthcare platform by a user who has appropriate access. This facilitates security and flexibility for use of the Ticket by the patient. As those skilled in the art will recognize, the barcode may be 2-D, hexagonal, and other various forms. The barcode layout may also be configured to be presented differently depending on the mobile device being used.

Additionally, barcodes and barcode scanners are not the only type of identification ticket mediums usable in conjunction with the digital healthcare platform. Rather, the Ticket identifier may be embodied in numerous other forms, such as smart card, RFID, or by being tied to other identification means.

A patient can have an arbitrary number of Tickets in the system to address distinct healthcare issues. However, in one embodiment, each Ticket is assigned to one healthcare issue action and only certain predefined services. This enables the Ticket to be used once at a plurality of specific physical locations for a contracted price. Further embodiments of the Ticket may include more comprehensive and focused patient referrals and treatment flow, such as referrals to specialists or other specialized care locations. Further embodiments also enable enhanced integration between the Ticket and insurance plans and coverage.

Third Party Provider Access to the Digital Healthcare Platform

Within the digital healthcare platform, a clinical module provides a user interface allowing the Ticket to interact with the platform database and locate the record and appropriate payment and clinical information. Each Clinic that is Ticket-“Enabled” provides secure logins or other authentication means to this interface for each agent of the third party healthcare provider. For example, before scanning a Ticket, a clinic worker navigates to a user interface and authenticates, by providing a login using a username/password. The user interface will then present the ability to obtain patient information using the digital healthcare platform.

The digital healthcare platform provides for the use of the Ticket at the clinical setting through a patient/ticket look-up interface. With this interface, the Ticket GUID is automatically entered via the barcode reader or manually typed. Then, the system displays a clinical interface to the third party healthcare provider as presented in FIG. 10. Thus, the interface provides for a different “mode” of the existing e-Visit interface unique to the patient Ticket encounters.

Before access is provided to the third party provider, a check is performed by the digital healthcare platform to ensure that the user-provided Ticket can be filled at this location. That is, if the Ticket is intended to be used only at a quick service clinic, the digital healthcare platform will reject it and it will not work if scanned at a regular clinic. If a Ticket is scanned at a location that is not supported, a message is presented to the clinician and/or the user. In one embodiment, the patient will be notified that they can visit other specific locations for service.

As previously described and illustrated in FIG. 9, one example involves the patient physically visiting a “Ticket-Enabled” third party health provider 930 and presenting the barcode Ticket 920 (in paper or electronic form) to the provider. The provider scans the barcode identifier 950 on the Ticket 920. Scanner 940 connected to the third party interface will obtain the correct GUID of the Ticket and obtain electronic access to the patient's data from the digital healthcare platform 960 via a network connection. Alternately, a provider 930 agent may type the Ticket GUID into a Ticket text field within the interface, or may use other techniques for identifying the patient, such as identifying the patient based on the Patient's Last name and Phone number, or some other unique identifier combination.

FIG. 10 shows an example list of action items presented to the third party healthcare provider in an interface 1000 upon use of the patient Ticket. At the top is basic demographic information 1010 about the patient and a link to the full PDF report 1020 generated from the e-Visit. Below this section is dynamic content, specifically details about the tests to run (a strep test 1031 and a mono spot 1032). Next to each of these tests are inputs to mark the results 1040 of the tests, and additional information 1050 relevant to the results and/or assessment.

The content within interface 1000 is generated in a similar fashion to the online clinical note and third party use of this interface will trigger events as appropriate. The screenshot depicted within FIG. 10 is interactive and makes the clinical encounter faster because the patient has already been triaged with the online e-Visit, thereby eliminating the need for any further triage and saving valuable time for both the patient and the clinic. In further embodiments, presentation of the patient Ticket may simply provide the health care provider with a link to a PDF of the online assessment, such as an assessment containing instructions to “visit a third party clinic for a full physical examination.” The character of the interface presented to the third party depends on the reason for the visit and specific content provided using the digital health platform.

In one embodiment, this data is provided to the third party health provider 930 in PDF format. It shows the response from the initial Ticket visit online and clearly identifies the action items (lab test, physical evaluation, etc.) recommended for the patient. At this time, (a) the Ticket becomes deactivated because once scanned, bar-code is de-linked so that it cannot be used more than one time, and (b) the location where the Ticket 920 was scanned is tracked by the digital healthcare platform 960. Ticket usage data is stored by the digital healthcare platform 960 for partners and third parties that participate in use of the Ticket.

Depending on the actions required by the third party health provider 930, the Ticket may be retired or remain active. In one embodiment, use of the Ticket at a third party healthcare provider will only require specific types of actions from the healthcare provider. For example, in a retail quick-service clinic environment, the actions that can be taken are limited to certain defined items. Thus the patient Ticket may only be valid for those tests or services offered by the quick-service clinic environment. A full physical evaluation or additional tests may not be possible at that retail clinic.

In one embodiment, a full patient exam is recommended for performance by the third party medical provider. In this case, the e-Visit assessment and history are available to review but no input from the third party is transmitted back to the digital healthcare platform. Using the Ticket triggers the data in the digital healthcare platform tracking where the patient went and when for the service. Additional data about the patient is stored by the third party healthcare provider and remains outside of the digital healthcare platform. In this case, the ticket is retired upon its use.

In another embodiment, specific tests and/or actions are performed by the third party medical provider. This includes a lab or test recommended by the digital healthcare platform that is run in a retail or clinic setting. The outcomes from this test are discrete and can be easily entered into the third party health provider interface 930 and transmitted to the digital healthcare platform 960. The Ticket/GUID is retired upon the clinician providing a plan of action that either requires no additional tests (strep tests, mono spots, etc.) or a physical evaluation at a third party medical provider. Thus, depending on the outcomes of the test, the patient may be manually or automatically referred to another clinic or the process may end.

Additionally, third party health providers can obtain, review, and utilize the clinician report without changing or modify their work flow/clinic issues. For example, the third party health provider may print the PDF file, or transfer the PDF file electronically to their electronic medical records (EMR) system and then submit the entire medical record for reimbursement at a clinic visit cost. There may also be arrangements made with each clinic/provider network to provide reduced cost services for certain users of the digital healthcare platform.

In one embodiment, patient data is captured via methods described above and encoded into text. The clinical note (output) may be generated into XML format, providing a mid-step translation enabling data to be processed at a variety of systems or formats. As previously described, the PDF format may be used to provide a proprietary wrapping of XML, but other suitable formats may be used as well. Those skilled in the art will recognize that data stored in XML format may also be stored and/or presented with use of HL7, HTML, CCR, and a variety of other formats. Likewise, the outputted PDF format serves as a “locked” note format and may be substituted by other types of formatting as appropriate.

Connection with External Medical Monitoring Devices

As discussed with reference to the numerous questions and data inputs received from a patient, the presently disclosed digital healthcare platform may be integrated with data collection features of external medical monitoring devices. In one embodiment, the digital healthcare platform may be used in conjunction with various devices, systems, and methods capable of collecting and processing medical data through inputs of a computing device, and particularly, the computing device used to access or interface with the digital healthcare platform. These inputs include a variety of wired and wireless mediums, including but not limited to RF, Bluetooth, 802.11, USB, serial, and analog and digital connections. Likewise, a number of medical monitoring peripherals and peripheral formats may be used in conjunction with the digital healthcare platform.

One type of external monitoring device used in conjunction with one embodiment of the present invention involves accessing data through a microphone input of a mobile computing device, such as a headset jack of a smartphone. This offers a particular advantage for patients because a microphone connection enables a simple, low-cost interface with mobile medical monitoring devices, such as pulse monitors, thermometers, and the like.

With particular reference to the technique of obtaining medical data through a headset jack, the computing device used to collect data from these medical monitoring devices may comprise a computer, cell phone, smartphone, audio player, or other mobile digital device that is capable of recording inputs from an external analog source. In addition, the mobile digital device may also execute some form of software designed to process and interpret the monitoring device data. Additionally, the mobile digital device may also be capable of displaying a representation of the monitoring device data, providing interpretation of the monitoring device data, transmitting the monitoring device data, and providing contextual material to the human user related to the monitoring device data.

This configuration enables a generic consumer tool for personal health monitoring, for use with simple medical monitoring devices that are typically not FDA regulated. Once the medical data is input from the monitoring device into the mobile computing device, a consumer can use the data as he or sees fit, and share it with a doctor, nurse, or other healthcare professional, or seek out his or her own methods of diagnosis and treatment.

Specifically, a microphone-connected form factor removes some of the existing limitations and inconveniences of obtaining data from medical monitoring devices, and presents numerous opportunities for additional processing of monitoring data in home and portable settings. Although the software may be configured to provide further diagnostics or seamlessly provide the captured medical data to a healthcare professional or the digital healthcare platform directly, the software may be operated to simply receive and display the monitoring data to the patient without any further processing.

One type of medical monitoring data collection involves the use of low cost, portable monitoring devices and transmission of the data to commonly used mobile computing devices through a headset plug. The mobile computing device may include but is not limited to a computer, cell phone, smartphone, music player, or other mobile digital device. The mobile computing device may also utilize software which is capable of gathering, displaying, and/or transmitting data collected from the medical device in audio form.

Some of the examples of the types of data collected from a human subject using the monitoring devices include measurements of temperature, pulse, and breathing. The various configurations described herein enable the collection of data from any medical device capable of transmitting data that is convertible into an audio signal, to establish communications via a standard computing device input, such as a microphone jack.

Other configurations may include functionality for performing diagnostics on the data collected from the monitoring devices within the mobile digital device. Additionally, the data may be transmitted to the digital healthcare platform and/or a selected provider (either automated or subject to human review) for further diagnostics. The collection or transmission of data at defined intervals may also be useful for medical test settings or for the verification of the user's vital data over time.

As an example of a type of medical monitoring device that may be adapted, the form factor of an ear bud microphone and speaker may be modified to function as a thermometer and measure a person's temperature (performed by directly capturing the person's temperature from his or her ear). The medical monitoring device then actively or passively transmits data via an analog audio representation to the microphone input of the mobile computing device. Further configurations include transmitting audio through a speaker connection from the mobile device at the same time of capturing audio input, such as providing audible instructions of how to properly place the device on the subject's body or otherwise use the medical device.

Another example of a medical monitoring device includes a device that captures a human pulse through an enhanced microphone. The microphone may be configured for placement on a strategic location of a subject person, and is sufficiently sensitive to record a human pulse when placed proximate to the subject's skin at that location. The audio may be transmitted in its raw form to the mobile computing device and recorded by the mobile computing device. Software on the mobile device interprets the relevant portions of audio signal into pulse signals and calculates a pulse rate.

This monitoring device, operated separately or in conjunction with the e-Visit functionality of the digital healthcare platform, may be used within a variety of informal home, work, and portable settings, and may also be applicable for use in professional medical settings. Likewise, the configurations described may be used with regulated or unregulated medical devices, and required data standards may determine the appropriateness of the communication scheme for unregulated minor medical devices. The portability provided by a headset-connected form factor enables medical data to be more easily collected and ported from monitoring devices connected to a human user, and therefore may have numerous applications in mobile locations by a user.

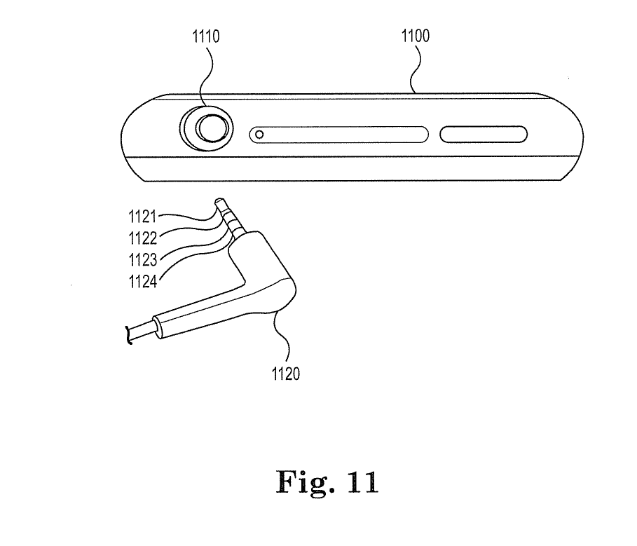

As an example of the type of connections utilized, FIG. 11 depicts a standard headset jack 1110 within a mobile phone 1100, configured to receive plug 1120 as known in the prior art. The headset jack 1110 includes a small, round female connector that accepts and holds the pin-shaped headset plug 1120 when inserted. The headset plug 1120 may be connectable to a variety of input/output audio devices, such as a standard phone headset, headphones, speakers, microphone, and the like. Common uses for the jack within a mobile phone enable connection to accessories such as a wired hands-free car kit speakerphone.

A 2.5 mm headphone connector is the most commonly used connector size within mobile phones, and is frequently used for both phone call audio functions and other audio functions controlled by the phone, such as a music player. The 3.5 mm headphone jack size is the most commonly used headphone connector size used for audio players and devices other than phones. Adapters exist in the art to enable interconnection of these two sizes. Either size can support a variety of configurations for audio input (in mono and stereo) and audio input, dependent on the number of connector rings within the plug and jack.

Within the headphone jack 1110 (the female end) and headphone plug 1120 (the male end), there are connector rings used to establish connections according to the various functions and number of inputs and outputs. Three-sleeve connectors are commonly known in the art by the interchangeable terms of phone plug, stereo plug, and TRS connector (consisting of a tip, ring, and sleeve). In typical use, one of the connectors is dedicated to a common ground, and the other connectors serve the role as a specific audio input or output channel. Common configurations of this type of connector involve those with two connectors (for transmission of a mono channel, either audio input or output); 3 connectors (for transmission of stereo audio output, or for transmission of mono output and mono input); and 4 connectors (for transmission of stereo audio output in addition to a microphone input).

As shown in FIG. 11, a 2.5 mm mobile phone stereo plug 1120 is depicted with four connectors, for use in smartphones. In this example, the four connectors of the plug are configured as follows: tip 1121 is used to communicate the right audio channel; ring 1122 is used to transmit the left audio channel; ring 1123 is used as the common (ground) connection; and the sleeve 1124 is used to serve as the microphone connector. The position of the microphone connector upon the sleeve enables the microphone connection to be shorted out with a longer sleeve, thereby enabling use of a three connector plug within the four connector jack.

Those skilled in the art will recognize that the role and position of the various connectors may be changed depending on the configuration of the device and the applications supported by the connected hardware. For example, additional audio inputs may be assigned to a connector, assigned to different connectors, or audio outputs may be removed entirely from a connector. Likewise, connectors may be adapted to enable use with connectors of different size (such as ¼″ TRS connectors) or a different form entirely.

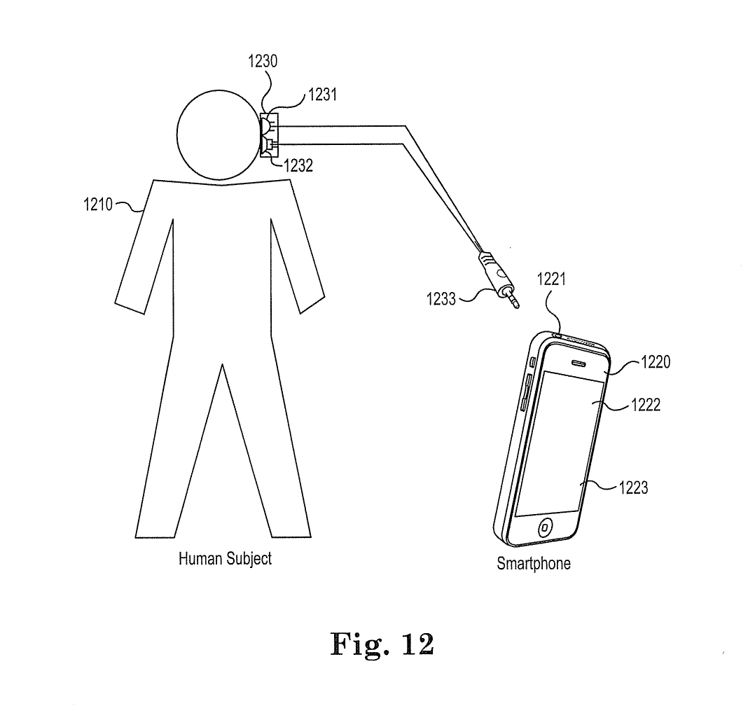

FIG. 12 depicts an example connection of a smartphone mobile device 1220 to a monitoring device 1230 capturing vital data on a human subject 1210. As shown, the monitoring device 1230 is attached to the ear region of the human subject 1210. Alternatively, the monitoring device 1230 may be attached to the neck region of the human subject 1210 or any other area on the human subject that is suitable for monitoring pulse or other vital data. The monitoring device contains a speaker 1231 and a microphone 1232 for the broadcast and capture of audio signals, respectively. A wire is connected to the speaker 1231 and microphone 1232 that terminates with a standard TRS connector plug 1233.

In this example, the monitoring device 1230 is configured with a sensitive earbud microphone to capture the pulse rate of the human subject using the microphone 1232 placed in the ear. As the blood vessels in or near the ear pulsate, audio of the pulsating rhythm are captured with a sensitive microphone. Additionally, in this example, the earbud speaker is configured to transmit audio instructions (such as to instruct the user to be quiet to more accurately capture the audio with the microphone 1232).

The TRS connector plug 1233 is configured to be inserted into the headset jack 1221 of the smartphone 1220. The smartphone 1220 contains functionality to record the audio signal obtained from the microphone 1232 of the monitoring device 1230 and transmit audio instructions to the speaker 1231. This functionality is in the form of software running on the smartphone which measures the user's pulse rate according to the contents of the recorded audio signal. For example, the monitoring device 1230 may be configured to measure the human subject's temperature, but rather than directly transmitting the temperature reading to the TRS connector plug 1233, the monitoring device 1230 first encodes the numeric temperature reading into a corresponding audio tone or series of audio tones. As such, based on a predetermined encoding scheme, monitoring device 1230 converts a temperature reading of 98.6° F. into a series of audio tones that are transmitted to the TRS connector plug 1233. The smartphone 1220 is configured, or runs an application that is configured, to decode the audio tones received by the smartphone 1220 into the corresponding temperature that was originally measured by the monitoring device 1230.

Once the audio signal has been interpreted into vital data within the smartphone 1220, the medical data can be applied to appropriate uses, including ultimate use with the digital healthcare platform or one of its user interfaces. As shown, the data (in this case, the pulse rate of the human subject) is displayed on a screen 1222. The smartphone may also be configured to automatically transmit this data via a network connection with the smartphone, such as to the digital healthcare platform, a medical monitoring service, or a medical provider. The user may also be presented options through an input keypad 1223 or similar input interface to transmit or otherwise use the medical data.

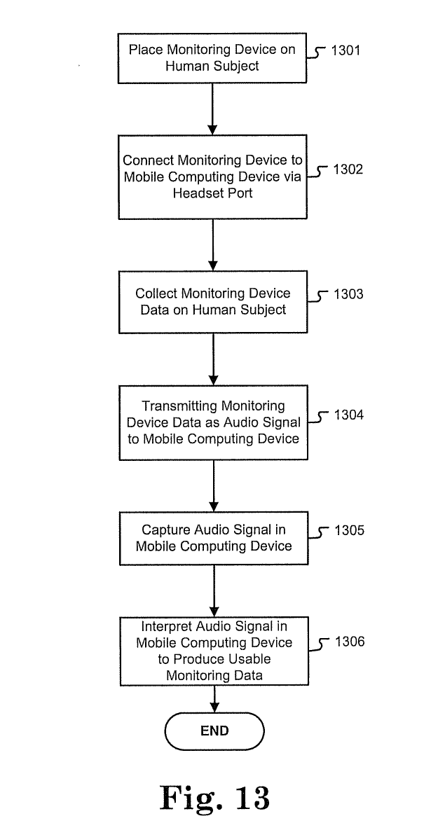

FIG. 13 depicts a sample flowchart of an operation for capturing and importing medical data through a headset microphone plug. Those skilled in the art will recognize that numerous modifications may be made to the sequence and actions of the following steps.

As in step 1301, the monitoring device is placed on the human subject. This monitoring device will typically be a small external monitoring apparatus, either held proximate or otherwise attached superficially to the human subject. Next, as in step 1302, the monitoring device is connected to the mobile computing device via a headset port (or like port which contains an audio input to the mobile computing device).

As in step 1303, the monitoring device data is collected on the human subject within the monitoring device. The monitoring device data is then transmitted as an audio signal to the mobile computing device as in step 1304. This data may either be sent in raw format, such as an audio recording directly within the monitoring device, it may involve an audio recording with a representation of the data values placed throughout the recording, or it may be based on the type of audio signal transmission from the monitoring device.

The mobile computing device receives the audio signal as an input in the headset microphone input, and proceeds to capture the audio signal as in step 1305. Once the audio signal content is within the mobile computing device, the audio signal content may be interpreted and processed for further use as in step 1306. This step may include an analog-to-digital conversion where appropriate to make the audio signal usable by the mobile computing device.

Although analog signals are typically transmitted and received via the standard headphone jacks within devices, the preceding techniques are also applicable to transmissions of audio signals through similar digital audio inputs, such as through an optical audio cable, S/PDIF component connections, a combination digital coax/analog combination jack, a digital line-in port on a sound card or other input device, or any other combination of digital and analog signal transmission.

As will be understood by one skilled in the art, various aspects of the digital healthcare platform and other embodiments of the present invention described herein may be embodied as a system, apparatus, method, or computer program product. Accordingly, inventive aspects of the present invention may be embodied through use of hardware, software (including firmware, embedded software, etc.), or a combination therein. Furthermore, aspects of the present invention may include a computer program product embodied in one or more computer readable storage medium(s) having computer readable program code embodied thereon.

Code for carrying out operations for aspects of the present invention may be written in any combination of one or more programming languages, including an object oriented programming language such as Java, C#, C++ or the like, conventional procedural programming languages, such as the “C” programming language, or languages configured for use in embedded hardware and other electronics. Further, the various components of the invention described in the drawings and the disclosure above may be implemented by executable program code or other forms of electronic and computer program instructions. These electronic and computer program instructions may be provided to a processor or microprocessor of a general purpose computer, special purpose computer, standalone electronic device, or other data processing apparatus to produce a particular machine, such that the instructions, which execute via a processor or other data processing apparatus, create suitable means for implementing the functions/acts specified in the present drawings and disclosure.

As would also be understood by one skilled in the art, network connections to the previously described devices and systems may be configured to occur through local area networks and networks accessible via the Internet and/or through an Internet service provider. Likewise, network connections may be established in wired or wireless forms, to enable a connection with a detached device such as a handheld, laptop, netbook, tablet, smartphone, or other mobile/portable device. For example, a suitable monitoring and control system may be accessible remotely by a third party user via a network connection.

Further, the devices, and systems described in the present disclosure may comprise general and special purpose computing systems, which may include various combinations of memory, primary and secondary storage devices (including non-volatile data storage), processors, human interface devices, display devices, and output devices. Such memory may include random access memory (RAM), flash, or similar types of memory, configured to store one or more applications, including but not limited to system software and applications for execution by a processor.

Examples of external computing machines which may interact with the presently disclosed methods, devices, and systems may include personal computers, laptop computers, notebook computers, netbook computers, network computers, mobile computing devices (including smartphones), Internet appliances, or similar processor-controlled devices. Those skilled in the art would also recognize that the previously described methods, devices, and systems may also be integrated with remote control, configuration, and monitoring activities via a web server, a web service, or other Internet-driven interface.

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method for facilitating a patient-driven electronic healthcare interaction with a patient using a mobile device, comprising:
performing a healthcare information intake relating to a healthcare issue of the patient using the mobile device;
receiving the healthcare information intake from the mobile device;
generating a plan of action for the patient to address the healthcare issue, the plan of action generated from a combination of clinician review of the healthcare information intake and assistance from a computerized expert system;
storing data relevant to the healthcare plan of action in a database;
associating the data relevant to the healthcare plan of action with an identifier;
displaying patient instructions for the healthcare plan of action on the mobile device, including providing a referral to a third party healthcare provider;
displaying the identifier on the mobile device for reading by the third party healthcare provider;
receiving the identifier read from the mobile device by the third party healthcare provider and identifying the healthcare plan of action associated with the identifier therewith; and
transmitting data relevant to the identified healthcare plan of action from the database to the third party healthcare provider.

2. The method of claim 1, wherein performing the healthcare information intake using a mobile device includes receiving data acquired from a medical monitoring device connected to the mobile device, and wherein generating the plan of action includes processing the data from the medical monitoring device with the computerized expert system.

3. The method of claim 2, wherein the medical monitoring device is directly connected to the mobile device via a microphone connection port.

4. The method of claim 1, wherein the referral to the third party healthcare provider includes providing information relating to screening, tests, evaluation, or treatment procedures to be conducted by the third party healthcare provider.

5. The method of claim 1, wherein the identifier is displayed on the mobile device as a barcode image.

6. A computer program product for facilitating a patient-driven electronic healthcare interaction with a patient using a mobile device, comprising:
a computer readable storage medium embodied with computer readable program code, the computer readable program code including code configured for:
performing a healthcare information intake relating to a healthcare issue of the patient using the mobile device;
receiving the healthcare information intake from the mobile device;
generating a plan of action for the patient to address the healthcare issue, the plan of action generated from a combination of clinician review of the healthcare information intake and assistance from a computerized expert system;
storing data relevant to the healthcare plan of action in a database;
associating the data relevant to the healthcare plan of action with an identifier;
displaying patient instructions for the healthcare plan of action on the mobile device, including providing a referral to a third party healthcare provider;
displaying the identifier on the mobile device for reading by the third party healthcare provider;
receiving the identifier read from the mobile device by the third party healthcare provider and identifying the healthcare plan of action associated with the identifier therewith; and
transmitting data relevant to the identified healthcare plan of action from the database to the third party healthcare provider.

7. The computer program product of claim 6, wherein performing the healthcare information intake using a mobile device includes receiving data acquired from a medical monitoring device connected to the mobile device, and wherein generating the plan of action includes processing the data from the medical monitoring device with the computerized expert system.

8. The computer program product of claim 7, wherein the medical monitoring device is directly connected to the mobile device via a microphone connection port.

9. The computer program product of claim 6, wherein the referral to the third party healthcare provider includes providing information relating to screening, tests, evaluation, or treatment procedures to be conducted by the third party healthcare provider.

10. The computer program product of claim 6, wherein the identifier is displayed on the mobile device as a barcode image.

11. A system, comprising:
a mobile device;
a computer system used for facilitating a patient-driven electronic healthcare interaction with a patient via the mobile device, the computer system configured to execute instructions for:
performing a healthcare information intake relating to a healthcare issue of the patient using the mobile device;
receiving the healthcare information intake from the mobile device;
generating a plan of action for the patient to address the healthcare issue, the plan of action generated from a combination of clinician review of the healthcare information intake and assistance from a computerized expert system;
storing data relevant to the healthcare plan of action in a database;
associating the data relevant to the healthcare plan of action with an identifier;
displaying patient instructions for the healthcare plan of action on the mobile device, including providing a referral to a third party healthcare provider;
displaying the identifier on the mobile device for reading by the third party healthcare provider;
receiving the identifier read from the mobile device by the third party healthcare provider and identifying the healthcare plan of action associated with the identifier therewith; and
transmitting data relevant to the identified healthcare plan of action from the database to the third party healthcare provider.

12. The system of claim 11, wherein performing the healthcare information intake using the mobile device includes receiving data acquired from a medical monitoring device connected to the mobile device, and wherein generating the plan of action includes processing the data from the medical monitoring device with the computerized expert system.

13. The system of claim 12, wherein the medical monitoring device is directly connected to the mobile device via a microphone connection port.

14. The system of claim 11, wherein the referral to the third party healthcare provider includes providing information relating to screening, tests, evaluation, or treatment procedures to be conducted by the third party healthcare provider.

15. The system of claim 11, wherein the identifier is displayed on the mobile device as a barcode image.
